(19) United States
(12) Patent Application Publication
(10) Pub. No.: US 2024/0191018 A1
(43) Pub. Date: Jun. 13, 2024

(54) AQUEOUS POLYURETHANE AND POLYURETHANE/POLY(METH)ACRYLATE HYBRID DISPERSIONS

(71) Applicant: BASF SE, Ludwigshafen am Rhein (DE)

(72) Inventors: Samane MEHRAVAR, Ludwigshafen am Rhein (DE); Manfred DARGATZ, Ludwigshafen am Rhein (DE); Paola URIBE AROCHA, Ludwigshafen am Rhein (DE); Daniel VON NESSEN, Ludwigshafen am Rhein (CN); Chintankumar Jayantilal PATEL, Ludwigshafen am Rhein (DE)

(21) Appl. No.: 18/286,773

(22) PCT Filed: Apr. 11, 2022
(86) PCT No.: PCT/EP2022/059639

§ 371 Date: Oct. 13, 2023

(30) Foreign Application Priority Data
Apr. 16, 2021 (EP) 21168957.5

(51) Int. Cl. C08G 18/34; C08G 18/10; C09D 175/06

(52) U.S. Cl. CPC C08G 18/348; C08G 18/10; C09D 175/06; C08G 2650/36

(57) ABSTRACT

The present invention relates a process of the present invention for the preparation of an aqueous composition comprising a polyurethane carrying COOH groups and/or salt groups thereof, comprises the steps of (i) reacting at least one first polyisocyanate (A1) with at least one polyol carrying at least one COOH group (BX) and optionally at least one first polyol carrying no COOH group (B1) to form a first composition (C1), (ii) treating the first composition (C1) obtained in step (i) with at least one second polyol carrying no COOH group (B2), and optionally with at least one second polyisocyanate (A2), to form a second composition (C2), and (iii) optionally treating the second composition (C2) obtained in step (ii) with at least one third-polyisocyanate (A3), to form a third composition (C3), wherein step (i) is stopped at a reaction index in the range of 0.05 to 0.94, wherein reaction index=reaction rate×[mol initial NCO groups of all A1/(mol initial OH groups of all BX and, if present, mol initial OH groups of all B1)] (formula 1) wherein reaction rate=1 minus (mol NCO groups of C1/mol initial NCO groups of all A1), and to an aqueous composition comprising a polyurethane carrying COOH groups and/or salt groups thereof obtainableby this process, to a process for the preparation of an aqueous composition comprising a polyurethane/poly(meth)acrylate hybrid polymer using the aqueous composition comprising a polyurethane carrying COOH groups and/or salt groups thereof of the present invention, to aqueous compositions comprising a polyurethane/poly(meth)acrylate hybrid polymer obtainable by the this process, to coating compositions comprising the aqueous composition comprising a polyurethane carrying COOH groups and/or salt groups thereof or the aqueous compositions comprising a polyurethane/poly(meth)acrylate hybrid polymer, and to substrates coated with these coating compositions.

The present invention relates to a process for the preparation of an aqueous composition comprising a polyurethane carrying COOH groups and/or salt groups thereof, to the aqueous composition comprising a polyurethane carrying COOH groups and/or salt groups thereof obtainable by this process, to a process for the preparation of an aqueous composition comprising a polyurethane/poly(meth)acrylate hybrid polymer using the aqueous composition comprising a polyurethane carrying COOH groups and/or salt groups thereof of the present invention, to aqueous compositions comprising a polyurethane/poly(meth)acrylate hybrid polymer obtainable by this process, to coating compositions comprising the aqueous composition comprising a polyurethane carrying COOH groups and/or salt groups thereof or the aqueous compositions comprising a polyurethane/poly(meth)acrylate hybrid polymer of the present invention, and to substrates coated with these coating compositions.

Processes for the preparation of aqueous polyurethane dispersions are known in the art.

US20160376438 describes a process for the preparation of an aqueous dispersion comprising polyurethane, which process comprises the steps of (i) preparing at least one hydroxy-functional prepolymer followed by (ii) reacting this hydroxy-functional prepolymer with at least one polyisocyanate. Example 14 describes a polyurethane prepared by first reacting a polyester diol, butan-1,4-diol, dimethylolpropionic acid and a monohydroxyfunctional polyether with isophorone diisocyanate to form an OH-functional prepolymer and reacting the OH-functional prepolymer with toluene diisocyanate to form a polyurethane with no OH groups.

EP2341110A1 describes a method for producing an aqueous polyurethane dispersion, which method comprises a first step of reacting a diol compound (A) which has one or two carboxyl groups within each molecule with a diisocyanate compound (B) and terminating the reaction at a reaction point where the reaction index falls within a range of 0.95 to 1.10 as calculated by formula (1), thereby producing a reaction product which is mainly composed of compound of the NCO-functional compound of formula OCN—R¹—NHC(═O)O—R²—OC(═O)NH—R³—NCO (1), wherein R² represent a partial structure of diol (A) which has one or two carboxyl groups within each molecule, and a second step of i) reacting the reaction product of step 1 and a diol compound (C) or ii) reacting the reaction product of step 1, a diol compound (C) and a diisocyanate compound (D). Formula (1) is as follows: reaction index=reaction rate of NCO group×[mol compound B/mol compound A], wherein the reaction rate of NCO group=1 minus [value NCO groups of the reaction product of step 1/value NCO groups of initial reaction mixture of step 1]). The aqueous polyurethane is suitable for use in an aqueous pigment dispersions. Example 1 describes a method for producing an aqueous OH-functional polyurethane, which method comprises a first step of reacting dimethylolpropionic acid with a tolyene diisocyanate in methyl ethyl ketone, and terminating the reaction at a reaction point where the reaction index is 0.98, and a second step of reacting the NCO-functional reaction product of step 1 and poly(oxytetramethylene)glycol) in methyl ethyl ketone, followed by treatment with methanol and NaOH, dispersion in water and removal of methyl ethyl ketone by distillation.

U.S. Pat. No. 5,569,707 describes aqueous dispersions of OH-functional polyurethanes having an acid number of 5 to 60 mg KOH/g, a hydroxyl number of 0.25 to 6.5 mg KOH/g and a urethane (NH—C(═O)—O) content of 2 to 25% by weight. The polyurethanes are obtained by reacting a) essentially linear polyester polyol different from b), b) an essentially difunctional polyol selected from the group consisting of i) polycarbonate polyol, ii) polyether polyol and iii) polyester polyol comprising units derived from a diol, which diol is derived from a fatty diacid, c) one or more compounds selected from i) hydroxy carboxylic acid, ii) aminoacid and iii) aminosulfonic acid, and f) a polyisicyanate. The polyurethanes exemplified in U.S. Pat. No. 5,569,707 are prepared using a batch-process. The polyurethane of example 4 is prepared by treating a mixture of polyester diol, polycarbonate diol, dimethylolpropionic acid, trimethylolpropane, tin(II) octoate and N-methylprrolidone with hexamethylenediisocyanate at 100° C., followed by neutralization with N,N-dimethylethnaolamine, and dispersion in water. U.S. Pat. No. 5,569,707 also describes coating compositions comprising a i) polyol component comprising 25 to 100% of the polyurethane resin and ii) a crosslinking resin.

U.S. Pat. No. 6,147,155 describes a process for preparing aqueous polyurethane dispersions, which process comprises the step of a) reacting a cyclic diisocyanate with a compound containing one or two isoyanate reactive-groups and at least one carboxylic acid or carboxylate group at a molar ratio of cyclic diisocyanate to compound containing one isoyanate reactive-group of at least 1:1 or at a molar ratio of cyclic diisocyanate to compound containing two isoyanate reactive-groups of at least 1.5:1 and b) adding a non-cyclic diisocyanate having 4 to 12 carbon atoms and a high molecular weight polyol having an number average molecular weight of 400 to 6000, in amounts such as i) the molar ratio of cyclic diisocyanate to non-cyclic diisocyanate is 4:6 to 9:1, and ii) the overall equivalent ratio of isocyanate groups to isocyanate reactive groups to prepare the NCO prepolymer is 1.1/to 2/1.

US2007265389 describes aqueous self-crosslinking polyurethane dispersions.

It was the object of the present invention to provide a process for the preparation of aqueous dispersions comprising a polyurethane carrying COOH groups and/or salt groups thereof, wherein the polyurethane particles have a small average particle size and at the same time a relative high density of COOH groups and salt groups thereof, and/or to provide aqueous aqueous dispersions comprising a polyurethane carrying COOH groups and/or salt groups thereof, wherein the polyurethane particles have a small average particle size and at the same time a relative high density of COOH groups and salt groups thereof.

This object is solved by the process for the preparation of aqueous dispersions comprising a polyurethane carrying COOH groups and/or salt groups thereof of claim 1, by the aqueous composition comprising a polyurethane carrying COOH groups and/or salt groups thereof of claim 12, by the process for the preparation of an aqueous composition comprising a polyurethane/poly(meth)acrylate hybrid polymer of claim 16, by the aqueous compositions comprising a polyurethane/poly(meth)acrylate hybrid polymer of claim 18, by the coating compositions of claim 20, and by the substrates of claim 22.

The process of the present invention for the preparation of an aqueous composition comprising a polyurethane carrying COOH groups and/or salt groups thereof, comprises the steps of
(i) reacting at least one first polyisocyanate (A1) with at least one polyol carrying at least one COOH group (BX) and optionally at least one first polyol carrying no COOH group (1) to form a first composition (C1),
(ii) treating the first composition (C1) obtained in step (i) with at least one second polyol carrying no COOH group (B2), and optionally with at least one second polyisocyanate (A2), to form a second composition (C2), and
(iii) optionally treating the second composition (C2) obtained in step (ii) with at least one third polyisocyanate (A3), to form a third composition (C3),
wherein step (i) is stopped at a reaction index in the range of 0.05 to 0.94,
wherein

reaction index=reaction rate×[mol initial NCO groups of all A1/(mol initial OH groups of all BX and, if present, mol initial OH groups of all 1)] (formula 1)
wherein
reaction rate=1 minus (mol NCO groups of C1/mol initial NCO groups of all A1).

The mol NCO groups of C1 is (NCO content of C1×weight C1)/molecular weight NCO.

The NCO content of C1 is weight NCO groups/weight C1.

The NCO content of C1 can be determined as follows:

10 mL of a 1 N solution of n-dibutyl amine in xylene is added to 1 g of C1 dissolved in 100 mL of N-methylpyrrolidone. The resulting mixture is stirred at room temperature for five minutes. Then, the resulting reaction mixture is subjected to back titration using 1 N hydrochloric acid to measure the volume of the hydrochloric acid needed for neutralizing the unreacted n-dibutyl amine.

This then reveals how much mol n-dibutyl amine reacted with NCO groups. The NCO content is (“mol reacted n-dibutyl amine”×molecular weight of NCO)/weight C1. The weight of C1 is 1 g.

The molecular weight of NCO is 42 g/mol.

The phrase “initial NCO groups of all A1” refers to the NCO groups of all A1 present at the start of the reaction of step (i). The phrase “initial OH groups of all BX” refers to the OH groups of all BX present at the start of the reaction of step (i). The phrase “initial OH groups of all 1” refers to the OH groups of all 1 present at the start of the reaction of step (i).

The first polyisocyanate (A1), the second polyisocyanate (A2) and the third polyisocyanate (A3) can be any aliphatic, alicyclic or aromatic polyisocyanate. The first polyisocyanate (A1), the second polyisocyanate (A2) and the third polyisocyanate (A3) can be the same or different.

The word “polyisocyanates” includes polyisocyanates carrying blocked NCO groups as well as polyisocyanates carrying free NCO groups. Polyisocyanates carrying blocked NCO groups, can be de-blocked to the corresponding polyisocyanate carrying free NCO groups under specific conditions, for example at elevated temperatures, such as at temperatures above 110° C. The polyisocyanate carrying blocked NCO groups is characterized in the following via its corresponding polyisocyanate carrying free NCO groups.

The NCO functionality of the polyisocyanate is usually in the range of from 1.6 to 10.

The NCO functionality of the polyisocyanate is NCO content×(molecular weight polyisocyanate/molecular weight NCO). If the polyisocyanate is a polymeric polyisocyanate, the average weight molecular weight of the polyisocyanate is used. The average weight molecular weight of a polymeric polyisocyanate can be determined using gel permeation chromatography calibrated to a polystyrene standard. The NCO content of the polyisocyanate is weight NCO/weight polyisocyanate.

The NCO content of the polyisocyanate can be determined as follows:

10 mL of a 1 N solution of n-dibutyl amine in xylene is added to 1 g of a polisocyanate dissolved in 100 mL of N-methylpyrrolidone. The resulting mixture is stirred at room temperature for five minutes. Then, the resulting reaction mixture is subjected to back titration using 1 N hydrochloric acid to measure the volume of the hydrochloric acid needed for neutralizing the unreacted n-dibutyl amine. This then reveals how much mol n-dibutyl amine reacted with NCO groups. The NCO content is (“mol reacted n-dibutyl amine”×molecular weight NCO)/weight polyisocyanate. The weight of polyisocyanate is 1 g.

Aromatic polyisocyanates are polyisocyanates, wherein at least one NCO functionality is directly attached to an aromatic ring. Alicyclic polyisocyanates comprise at least one alicyclic ring and each NCO functionality is not directly attached to an aromatic ring. Aliphatic polyisocyanates do not comprise an alicyclic ring and each NCO functionality is not directly attached to an aromatic ring. Preferred aliphatic and alicyclic polyisocyanates do not comprise aromatic rings.

The polyisocyanate can be a monomeric polyisocyanate or polymeric polyisocyanate.

Examples of monomeric aliphatic polyisocyanates having two NCO functionalities are tetramethylene 1,4-diisocyanate, pentamethylene 1,5-diisocyanate, hexamethylene 1,6-diisocyanate, heptamethylene 1,7-diisocyanate, octamethylene 1,8-diisocyanate, decamethylene 1,10-diisocyanate, dodecamethylene 1,12-diisocyanate, tetradecamethylene 1,14-diisocyanate, methyl 2,6-diisocyanatohexanoate, ethyl 2,6-diisocyanatohexanoate, 2,2,4-trimethylhexane 1,6-diisocyanate and 2,4,4-trimethylhexane 1,6-diisocyanate.

Examples of monomeric alicyclic polyisocyanates having two NCO functionalities are 1,4-diisocyanatocyclohexane, 1,3-diisocyanatocyclohexane, 1,2-diisocyanatocyclohexane, 4,4′-di(isocyanatocyclohexyl)methane, 2,4′-di(isocyanatocyclohexyl)methane, 1-isocyanato-3,3,5-trimethyl-5-(isocyanatomethyl)cyclohexane (isophorone diisocyanate), 1,3-bis(isocyanatomethyl)cyclohexane, 1,4-bis(isocyanatomethyl)cyclohexane, 2,4-diisocyanato-1-methylcyclohexane, 2,6-diisocyanato-1-methylcyclohexane and 3(or 4), 8(or 9)-bis (isocyanatomethyl)tricyclo[5.2.1.0(2,6)]decane.

Examples of monomeric aromatic polyisocyanates having two NCO functionalities are 2,4-tolylene diisocyanate, 2,6-tolylene diisocyanate, m-xylylene diisocyanate, p-xylylene diisocyanate, 2,4′-diisocyanatodiphenylmethane, 4,4′-diisocyanatodiphenylmethane, 1,3-phenylene diisocyanate, 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene and diphenyl ether 4,4′-diisocyanate.

Examples of monomeric aliphatic polyisocyanates having three NCO functionalities are 1,4,8-triisocyanatononane and 2′-isocyanatoethyl 2,6-diisocyanatohexanoate.

Examples of monomeric aromatic polyisocyanates having three NCO functionalities are 2,4,6-triisocyanatotoluene, triphenylmethane triisocyanate and 2,4,4′-triisocyanatodiphenyl ether.

Monomeric polyisocyanates can be prepared by methods known in the art, for example by treating the corresponding amines with phosgene.

Polymeric polyisocyanate usually comprises at least two units derived from a monomeric polyisocyanate.

The polymeric polyisocyanate preferably comprises (i) at least two units independently derived from the group consisting of monomeric aliphatic, alicylic and aromatic polyisocyanates, and (ii) at least one structural unit selected from the group consisting of uretdione, isocyanurate, biuret, urea, carbodiimide, uretonimine, urethane, allophanate, oxadiazinetrione and iminooxadiazinedione.

Examples of polymeric aliphatic polyisocyanate are hexamethylene 1,6-diisocyanate trimer, isophorone diisocyanate trimer and pentamethylene diisocyanate trimer.

The polymeric polyisocyanate can be prepared by methods known in the art.

The first polyisocyanate (A1) is preferably an aliphatic or alicyclic polyisocyanate having an NCO functionality in the range of 1.8 to 5.0, more preferably an aliphatic or alicyclic polyisocyanate having an NCO functionality in the range of 1.8 to 3.2, even more preferably an aliphatic or alicyclic polyisocyanate having an NCO functionality in the range of 1.8 to 2.5, most preferably a monomeric aliphatic or alicyclic polyisocyanate having two NCO functionalities, and in particular a monomeric aliphatic polyisocyanate having two NCO functionalities selected from the group consisting of tetramethylene 1,4-diisocyanate, pentamethylene 1,5-diisocyanate, hexamethylene 1,6-diisocyanate, heptamethylene 1,7-diisocyanate and octamethylene 1,8-diisocyanate, and most particular hexamethylene 1,6-diisocyanate.

The amount of aliphatic polyisocyanates is preferably at least 30% by weight, more preferably at least 50% by weight, even more preferably at least 70% by weight and most preferably at least 80% by weight, based on the weight of all polyisocyanates (A1).

The second polyisocyanate (A2) is preferably an aliphatic or alicyclic polyisocyanate having an NCO functionality in the range of 1.8 to 5.0, more preferably an aliphatic or alicyclic polyisocyanate having an NCO functionality in the range of 1.8 to 3.2, and most preferably an aliphatic or alicyclic polyisocyanate having an NCO functionality in the range of 1.8 to 2.5.

The third polyisocyanate (A3) is preferably an aliphatic or alicyclic polyisocyanate having an NCO functionality in the range of 1.7 to 10.0, more preferably an aliphatic or alicyclic polyisocyanate having an NCO functionality in the range of 1.8 to 5.0, more preferably an aliphatic or alicyclic polyisocyanate having an NCO functionality in the range of 1.8 to 4.0, most preferably a polymeric aliphatic polyisocyanate having an NCO functionality in the range of 1.8 to 3.2, and in particular hexamethylene 1,6-diisocyanate trimer.

The polyol carrying at least one COOH group (BX) can be any aliphatic, alicyclic or aromatic polyol carrying at least one COOH group.

The OH functionality of the polyol carrying at least one COOH group (BX) is usually in the range of from 1.7 to 6.0, more preferably in the range of 1.8 to 5.0, even more preferably in the range of 1.8 to 3.0, most preferably in the range from 1.8 to 2.4, and in particular in the range of 1.9 to 2.2.

The OH functionality of a polyol is (hydroxyl number polyol [g KOH/g]×molecular weight polyol)/molecular weight KOH. If the polyol is a polymeric polyol, the number average molecular weight of polyol is used. The number average molecular weight of a polymeric polyol can be determined using gel permeation chromatography calibrated to a polystyrene standard. The molecular weight of KOH is 56 g/mol. The hydroxyl number of the polyol can be determined according to DIN53240, 2016.

Aromatic polyols carrying at least one COOH group are polyols carrying at least one COOH group, wherein at least one OH functionality is directly attached to an aromatic ring. Alicyclic polyols carrying at least one COOH group comprise at least one alicyclic ring and each OH functionality is not directly attached to an aromatic ring. Aliphatic polyols carrying at least one COOH group do not comprise an alicyclic ring and each OH functionality is not directly attached to an aromatic ring. Preferred aliphatic and alicyclic polyols carrying at least one COOH group do not comprise aromatic rings.

Examples of polyols carrying at least one COOH group (BX) are 2,2-bis(hydroxymethyl) C₂₋₁₀-alkanoic acid such as 2,2-bis(hydroxymethyl) propionic acid (dimethylolpropionic acid), 2,2-bis(hydroxymethyl) butanoic and 2,2-bis(hydroxymethyl) pentanoic acid.

The polyol carrying at least one COOH group (BX) is preferably an aliphatic or alicyclic polyol carrying at least one COOH group, more preferably an aliphatic polyol carrying at least one COOH group.

The polyol carrying at least one COOH group (BX) preferably has a number average molecular weight of below 750 g/mol, more preferably of below 500 g/mol, and most preferably of below 250 g/mol.

The polyol carrying at least one COOH group (BX) preferably carries one COOH group.

Preferably, the polyol carrying at least one COOH group (BX) is an aliphatic or alicyclic polyol having an OH functionality of in the range of 1.8 to 2.4, a number average molecular weight below 500 g/mol, preferably below 250 g/mol, and carrying one COOH group. More preferably, the polyol carrying at least one COOH group (BX) is selected from the group consisting of 2,2-bis(hydroxymethyl) propionic acid and 2,2-bis(hydroxymethyl). The polyol carrying at least one COOH group (1) is most preferably 2,2-bis(hydroxymethyl) propionic acid.

The first polyol carrying no COOH group (1) and the second polyol carrying no COOH group (B2) can be any suitable polyol carrying no COOH group. The first polyol carrying no COOH group (1) and the second polyol carrying no COOH group (B2) can be the same or different.

The OH functionality of the first polyol carrying no COOH group (1) and of the second polyol carrying no COOH group (B2) is usually in the range of from 1.6 to 8.

The first polyol carrying no COOH group (1) and the second polyol carrying no COOH group (B2) can be any aliphatic, alicyclic or aromatic polyol carrying no COOH group.

Aromatic polyols are polyols carrying no COOH group, wherein at least one OH functionality is directly attached to an aromatic ring. Alicyclic polyols carrying no COOH group comprise at least one alicyclic ring and each OH functionality is not directly attached to an aromatic ring. Aliphatic polyols carrying no COOH group do not comprise an alicyclic ring and each OH functionality is not directly attached to an aromatic ring. Preferred aliphatic and alicyclic polyols carrying no COOH group do not comprise aromatic rings.

Examples of aliphatic polyols carrying no COOH group are aliphatic polyols carrying no COOH group and having two OH functionalities such as ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, heptane-1,7-diol, octane-1,8-diol, octane-1,2-diol, nonane-1,9-diol, decane-1,2-diol, decane-1,10-diol, dodecane-1,2-diol, dodecane-1,12-diol, hexa-1,5-diene-3,4-diol, neopentyl glycol, 2-methyl-pentane-2,4-diol, 2,4-dimethyl-pentane-2,4-diol, 2-ethyl-hexane-1,3-diol, 2,5-dimethyl-hexane-2,5-diol, 2,2,4-trimethyl-pentane-1,3-diol, pinacol and hydroxypivalinic acid neopentyl glycol ester.

Further examples of aliphatic polyols carrying no COOH group are diethylene glycol, triethylene glycol, dipropylene glycol, tripropylene glycol, polyethylene glycols, polypropylene glycols, polyethylene-polypropylene glycols, the sequence of the ethylene oxide or propylene oxide units being blockwise or random, polytetramethyleneglycols, polytetrahydrofurane diol and polycaprolactone diol.

Further examples of aliphatic polyols carrying no COOH group are aliphatic polyols carrying no COOH group and having at least three OH functionalities such as glycerol, trimethylolmethane, 1,1,1-trimethylolethane, 1,1,1-trimethylolpropane, 1,2,4-butanetriol, pentaerythritol, 1,3,5-tris(2-hydroxyethyl)isocyanurate, diglycerol, triglycerole, condensates of at least four glycerols, di(trimethylolpropane), di(pentaerythritol), and condensates of aliphatic compounds carrying at least three OH groups with ethylene oxide, propylene oxide and/or butylene oxide.

Examples of alicyclic polyols carrying no COOH group are alicyclic polyols carrying no COOH group and having two OH functionalities such as 1,1-bis(hydroxymethyl)-cyclohexane, 1,2-bis(hydroxymethyl)-cyclohexane, 1,3-bis(hydroxymethyl)-cyclohexane, 1,4-bis(hydroxymethyl)cyclohexane, 1,1-bis(hydroxyethyl)-cyclohexane, 1,2-bis(hydroxyethyl)-cyclohexane, 1,3-bis(hydroxyethyl)-cyclohexan, 1,4-bis(hydroxyethyl)-cyclohexane, 2,2,4,4-tetramethyl-1,3-cyclobutandiol, cyclopentane-1,2-diol, cyclopentane-1,3-diol, 1,2-bis(hydroxymethyl) cyclopentane, 1,3-bis(hydroxymethyl) cyclopentane, cyclohexane-1,2-diol, cyclohexane-1,3-diol, cyclohexane-1,4-diol, cycloheptane-1,3-diol and cycloheptane-1,4-diol and cycloheptane-1,2-diol.

Further examples of alicyclic polyols carrying no COOH group are alicyclic polyols carrying no COOH group and having at least three OH functionalities such are inositol, sugars such as glucose, fructose and sucrose, sugar alcohols such as sorbitol, mannitol, threitol, erythritol, adonitol (ribitol), arabitol (lyxitol), xylitol, dulcitol (galactitol), malitol and isomalt, as well as tris(hydroxymethyl)amine, tris(hydroxyethyl)amine and tris(hydroxypropyl)amine.

Examples of polyols carrying no COOH group are also polyester polyols carrying no COOH group, polycarbonate polyols carrying no COOH group, polyether polyols carrying no COOH group, polythioether polyols carrying no COOH group and polyacrylate polyols carrying no COOH group.

Polyester polyols carrying no COOH groups are polymers having at least two ester groups and carrying at least two OH groups and carrying no COOH group Polyester polyols carrying to no COOH group may comprise further linking groups in lower number or equal than the number of ester groups such as carbonate, ether, thioether or urethane groups. Preferred polyester polyols carrying no COOH group are polyester polyols carrying no COOH group, wherein the ratio mol ester groups/mol other linking groups is at least 70/1, more preferably at least 80/1.

Polyester polyols carrying no COOH groups can be prepared by methods known in the art such as by reacting at least one polyacid having a COOH functionality of two with a polyol having an OH functionality of two. Examples of polyacids having a COOH functionality of two are aliphatic polyacids such as oxalic acid, malonic acid, succinic acid, glutaric acid, adipic acid, pimelinic acid, suberic acid, azelaic acid, sebacic acid, 1,11-undecanedicarboxylic acid, 1,12-dodecanedicarboxlylic acid, maleic acid, fumaric acid, 2-methylmalonic acid, 2-ethylmalonic acid, 2-methylsuccinic acid, 2-ethylsuccinic acid, itaconic acid, 3,3-dimethylglutaric acid, 2-phenylmalonic acid 2-phenylsuccinic acid, alicyclic polyacids such as cyclopentane-1,2-dicarboxylic acid, cyclopentane-1,3-dicarboxylic acid, cyclohexane-1,2-dicarboxylic acid, cyclohexane-1,3-dicarboxylic acid, cyclohexane-1,4-dicarboxylic acid, cycloheptane-1,2-dicarboxylic acid, 1,2-bis(carboxymethyl)-cyclohexane, 1,3-bis(carboxymethyl)-cyclohexane and 1,4-bis(carboxymethyl)-cyclohexane, and aromatic polyacids such as 2-5-furandicarboxylic acid, phthalic acid, isophthalic acid, terephthalic acid and bis(4-carboxyphenyl) methane. Examples of polyol having an OH functionality of two are given above.

Polycarbonate polyols carrying no COOH groups are polymers having at least two carbonate groups in the main chain of the polymer and carrying at least two OH groups and carrying no COOH groups. Polycarbonate polyols carrying no COOH groups may comprise further linking groups in the main chain in lower number than the number of carbonate groups such as ester, ether, thioether or urethane linkages. Examples of polycarbonates carrying no COOH groups are polycarbonates carrying no COOH groups comprising units derived from the group consisting of butan-1,4-diol, pentane-1,5-diol and hexane-1,6-diol. Preferred polyestercarbonate polyols carrying no COOH groups are polycarbonate polyols carrying no COOH groups, wherein the ratio mol carbonate groups/mol other linking groups is at least 70/1, more preferably at least 80/1.

Polyether polyols carrying no COOH groups are polymers having at least two ether groups in the main chain of the polymer and carrying at least two OH groups and carrying no COOH groups. Polyether polyols carrying no COOH groups may comprise further linking groups in the main chain in lower number than the number of ether groups such as ester, carbonate, thioether or urethane linkages.

Polythioether polyols carrying no COOH groups are polymers having at least two thioether groups in the main chain of the polymer and carrying at least two OH groups and carrying no COOH groups. Polythioether polyols carrying no COOH groups may comprise further linking groups in the main chain in lower number than the number of ether groups such as ester, carbonate, ether or urethane linkages.

Poly(meth)acrylate polyols carrying no COOH groups are polymers comprising at least two units derived from (meth)acrylic acid ester monomers carrying at least one OH group such as 2-hydroxyethyl acrylate and 2-hydroxyethyl methacrylate and carrying no COOH groups.

The first polyol carrying no COOH group (1) and the second polymer carrying no COOH group (B2) have preferably independently from each other a number average molecular weight of at least 750 g/mol, more preferably of at least 1000 g/mol. The first polyol carrying no COOH group (1) and the second polymer carrying no COOH group (B2) can have a maximum number average molecular weight of 5000 g/mol, more preferably of 3000 g/mol.

The first polyol carrying no COOH group (1) and the second polymer carrying no COOH group (B2) have preferably independently from each other an OH functionality in the range of from 1.8 to 3.5, and more preferably in the range of from 1.8 to 2.4.

The first polyol carrying no COOH group (1) and the second polymer carrying no COOH group (B2) are preferably independently from each other selected from the group consisting of polyester polyol carrying no COOH groups, polycarbonate polyol carrying no COOH groups and polyether polyol carrying no COOH groups. More preferably, the first polyol carrying no COOH group (1) and the second polymer carrying no COOH group (B2) are a polyester polyol carrying no COOH groups.

The first polyol carrying no COOH group (1) and the second polymer carrying no COOH group (B2) have preferably independently from each other a hydroxyl number in the range of 10 to 250 mg KOH/g polyol, more preferably in the range of 20 to 200 mg KOH/g polyol, even more preferably in the range of 30 to 150 mg KOH/g, and most preferably in the range of 35 to 120 mg KOH/g.

Step (i), step (ii) and, if present, step (iii) are preferably performed in the presence of at least one organic solvent. The organic solvent used in step (i), step(ii) and step (iii), respectively, can be the same or different, usually the organic solvent in step (i), step (ii) and step (iii), if present, are the same.

The organic solvent can be an aliphatic ketone such as acetone, ethyl methylketone or isobutyl methyl ketone, an aliphatic amide such as N-methylpyrrolidone or N-ethylpyrrolidone, an ether such as tetrahydrofuran, dipropylene glycol dimethyl ether or dioxane, a hydrocarbon such as n-heptane, cyclohexane, toluene, ortho-xylene, meta-xylene, para-xylene, and xylene isomer mixture, an ester such as butyl acetate, an acid such as acetic acid or a nitrile such as acetonitrile, or a mixture thereof.

The at least one organic solvent is preferably an aliphatic ketone, and more preferably an aliphatic ketone selected from the group consisting of acetone and ethyl methyl ketone.

Step (i), step (ii) and step (iii) can be performed in the presence of at least one catalyst. The catalyst used in step (i), step (ii) and step (iii), respectively, can be the same or different.

Examples of catalysts are amine catalysts carrying at least one tertiary amino group and organometal catalysts.

Examples of amine catalysts carrying at least one tertiary amino group are 1,4-diazabicyclo[2.2.2]octane, N-methylmorpholine, N-methylimidazole, bis[2-(N,N-dimethylamino)ethyl] ether, 2,2′-dimorpholinyldiethylether and tetramethylethylenediamine, dimethylcyclohexylamine, dimethylbenzylamine, dimethylethanolamine and dimethylaminopropyl amine.

Examples of organometallic catalysts are organo titanium catalysts, organo tin catalysts, organo zinc catalysts, organo bismuth catalysts, organo zirconium catalysts, organo iron catalysts, organo aluminum catalysts, organo manganese catalysts, organium nickel catalysts, organo cobalt catalysts, organo molybdenum catalysts, organo tungsten catalysts and organo vanadium catalysts.

Examples of organo titanium catalysts are titanium(IV) tetra(isopropoxide) and titanium(IV) tetra(butoxide). Examples of organo tin catalyst are tin(II) diacetate, tin(II) di(2-ethylhexanoate), tin(II) dilaurate, dimethyltin(IV) diacetate, dibutyltin(IV) diacetate, dibutyltin(IV)dibutyrate, dibutyltin di(2-ethylhexanoate), dibutyltin(IV) dilaurate, dioctyltin(IV) dilaurate, dioctyltin(IV) diacetate, dibutyl tin(IV) oxide, diphenyl tin(IV) oxide, dibutyltin(IV) dichloride, and dibutyl tin(IV) maleate. Examples of organo zinc catalyst are zinc(II) diacetate, zinc(II) di(2-ethylhexanoate) and zinc(II) dineodecanoate. Examples of organo bismuth catalyst are bismuth(II) diacetate, bismuth(II) dipivalate, bismuth(II) di(2-ethylhexanoate) and bismuth(II) dineodecanoate. Examples organo zirconium catalysts are zirconium(IV) tetra(acetylacetonate) and zirconium(IV) etrakis(2,2,6,6-tetramethyl-3,5-heptanedionate).

Preferably, step (i) of reacting at least one first polyisocyanate (A1) with at least one polyol carrying at least one COOH group (BX) and optionally a first polyol carrying no COOH group (B1) to form a first composition (C1) is stopped at a reaction index in the range of 0.10 to 0.80, more preferably, in the range of 0.20 to 0.75, even more preferably in the range of 0.30 to 0.70, and most preferably in the range of 0.35 to 0.55.

Preferably, step (i) of reacting at least one first polyisocyanate (A1) with at least one polyol carrying at least one COOH group (BX) and optionally a first polyol carrying no COOH group (B1) to form a first composition (C1) is stopped at a reaction index in the range of 0.1 to 0.8, more preferably, in the range of 0.2 to 0.7, even more preferably in the range of 0.3 to 0.6, and most preferably in the range of 0.4 to 0.6.

Preferably, step (i) is performed in the presence of at least one organic solvent. If step (i) is performed in the presence of at least one organic solvent, the ratio of weight organic solvent/(weight of all A1, BX and 1) is preferably in the range of 20 to 90%, more preferably, in the range of 35 to 70%, most preferably in the range of 40 to 65%.

If the first polyol carrying no COOH group (1) is present in step (i), the ratio mol initial OH groups of all BX/mol initial OH group of all 1 is preferably in the range of 10/1 to 1.1/1, more preferably in the range of 5/1 to 1.5/1, and most preferably in the range of 3/1 to 2/1.

In a preferred embodiment, the first polyol carrying no COOH group (1) is not present in step (i).

Preferably, step (i) is performed in the absence of a catalyst.

Preferably, the step (i) is performed at a temperature of the reaction mixture of 20 to 150° C., more preferably at a temperature of 35 to 120° C., even more preferably at a temperature of 40 to 90° C., and most preferably at a temperature of 50 to 70° C.

The ratio (mol initial NCO groups of all A1)/(mol initial OH groups of all BX and, if present, mol initial OH of all 1) in step (i) is preferably in the range of 4/1 to 0.5/1, more preferably in the range of 2.5/1 to 0.8/1, even more preferably in the range of 1.5/1 to 0.9/1, and most preferably in the range of 1.22/1 to 1.05/1.

The reaction rate of step (i) is monitored by measuring the NCO content of the first composition (C1) and calculated according to formula reaction rate=1 minus (mol NCO groups of C1/mol initial NCO groups of all A1).

The reaction rate of step (i) is preferably in the range of 0.1 to 0.8, more preferably in the range of 0.2 to 0.7, and most preferably in the range of 0.3 to 0.6.

The reaction index of step (i) is monitored by measuring the NCO content of the first composition (C1) and calculating the reaction index according to formula (1) as specified above.

The first composition (C1) comprises various prepolymers comprising at least one urethane linkage formed by reaction of at least one polyisocyanate (A1) with at least polyol carrying at least one COOH group (BX), and if present, with the at least one first polyol carrying no COOH group (B1).

Step (i) is stopped at a reaction index in the range of 0.05 to 0.94, preferably in the range of 0.10 to 0.80, more preferably, in the range of 0.20 to 0.70, even more preferably in the range of 0.30 to 0.60, and most preferably in the range of 0.35 to 0.55, by proceeding to step (ii).

Step (i) is preferably stopped at a reaction index in the range of 0.1 to 0.8, more preferably, in the range of 0.2 to 0.7, even more preferably in the range of 0.3 to 0.6, and most preferably in the range of 0.4 to 0.6, by proceeding to step (ii).

Preferably, step (ii), the treatment of the first composition (C1) obtained in step (i) with at least one second polyol carrying no COOH group (B2), and optionally with at least one second polyisocyanate (A2) to obtain a second composition (C2) is performed in the presence of at least one organic solvent.

If step (ii) is performed in the presence of at least one organic solvent, the ratio of weight organic solvent/(weight of all A1, BX, 1, B2, and, if present, A2) is preferably in the range of 5 to 80%, more preferably, in the range of 10 to 60%, most preferably in the range of 20 to 40%.

Preferably, step (ii) is performed in the absence of a catalyst.

Preferably, the step (ii) is performed at a temperature of the reaction mixture of 20 to 150° C., more preferably at a temperature of 35 to 120° C., even more preferably at a temperature of 40 to 95° C., and most preferably at a temperature of 50 to 80° C.

The ratio of (mol initial OH groups of all BX and, if present, mol initial OH groups of all 1)/(mol OH groups of all B2) is preferably in the range of 5/1 to 1/5, more preferably in the range of 3/1 to 1/3, even more preferably in the range of 2/1 to 1/2, and most preferably in the range of 1.5/1 to 1/1.

Preferably, the second polyisocyanate (A2) is not present in step (ii).

Step (ii) is usually stopped when the NCO content of the second composition (C2) is below 0.05%. Step (ii) can be stopped, for example, by proceeding to step (iii) or by cooling the second composition (C2) to a temperature in the range of 15 to 30° C.

Preferably, step (iii) is the treatment of the second composition (C2) obtained in step (ii) with at least one third polyisocyanate (A3), to form a third composition (C3).

Step (iii) is preferably performed in the presence of at least one organic solvent.

If step (iii) is performed in the presence of at least one organic solvent, the ratio of weight organic solvent/(weight of all A1, 1, B2, if present A2, and A3) is preferably in the range of 5 to 80%, more preferably, in the range of 10 to 60%, most preferably in the range of 20 to 40%.

Preferably, step (iii) is performed in the absence of a catalyst.

Preferably, the step (iii) is performed at a temperature of the reaction mixture of 20 to 150° C., more preferably at a temperature of 35 to 120° C., even more preferably at a temperature of 40 to 95° C., and most preferably at a temperature of 50 to 80° C.

The ratio of (mol initial NCO groups of all A1)/(mol NCO groups of all A3) is preferably in the range of 50/1 to 1/1, more preferably in the range of 40/1 to 5/1, even more preferably in the range of 30/1 to 7/1, and most preferably in the range of 25/1 to 10/1.

The ratio of (mol NCO groups of all A1, if present of all A2, and of all A3)/(mol OH groups of all BX, if present of all B1, and of all B2) is preferably in the range of 10/1 to 1/10 more preferably in the range of 5/1 to 1/5, even more preferably in the range of 1/1 to 1/5, and most preferably in the range of 1/1.1 to 1/3.

Preferably, no additional polyol carrying no COOH group is added in step (iii).

Step (iii) is usually stopped when the NCO content of the third composition (C3) is below 0.05%. Step (iii) can be stopped, for example, by cooling the third composition (C3) to a temperature in the range of 15 to 30° C.

The process of the present invention for the preparation of an aqueous composition comprising a polyurethane carrying COOH groups and/or salt groups thereof, usually also comprises the steps of
(iv) diluting the second composition (C2) obtained in step (ii), or if step (iii) is present, the third composition (C3) obtained in step (iii) with at least one organic solvent to obtain a fourth composition
(v) treating the fourth composition obtained in step (iv) with at least one base to form a fifth composition,
(vi) dispersing the fifth composition in water,
(vii) removing at least part, preferably all, of the organic solvent of the dispersion obtained in step (vi) to form a sixth composition, and
(viii) optionally adding at least one additive to the sixth composition obtained in step (vii)

The organic solvent in step (iv) can be selected from the list of solvents given for the organism solvents of step (i), step (ii) and step (iii), if present, above. Usually the organic solvent in step (iv) is the same than the organic solvent used in step (i), step (ii) and step (iii), if present.

After dilution, the ratio of weight organic solvent/(weight of all A1, BX, if present 1, B2, if present A2, and, if present, A3 is preferably in the range o 30 to 80%, more preferably, in the range of 40 to 60%.

The base used in step (v) can be an inorganic base, ammonia or an amine carrying only one amino group.

Examples of inorganic bases are alkali and alkaline earth metal hydroxide, alkali and alkaline earth metal carbonate as well as alkali and alkaline earth metal hydrogencarbonate. Preferred inorganic bases are alkali metal hydroxide such as sodium or potassium hydroxide, alkali metal carbonate such as sodium carbonate and potassium carbonate as well as alkali metal hydrogencarbonate such as sodium hydrogen carbonate and potassium hydrogen carbonate.

The amino group of the amine carrying only one amino group can be a primary, secondary or tertiary amino group.

Examples of amines carrying only one primary amino group are n-butylamine, n-hexylamine, 2-ethyl-1-hexylamine, ethanolamine, 3-methoxypropylamine, 2-(2-aminoethyoxy)ethanol, 2-amino-1-propanol, 3-amino-propanol, 2-amino-butan-1-ol, benzylamine, 1-(3-aminopropyl) imidazole, tetrahydrofurfurylamine and cyclohexylamine.

Examples of amine carrying only one secondary amino group are dimethylamine, diethylamine, diisopropylamine, di-n-butylamine, diethanolamine, dipropanolamine, piperidine, pyrrolidine and morpholine.

Examples amines carrying only one tertiary amino group are triethanolamine, tripropanolamine, N-methyldiethanolamine, N-ethyldiethanolamine, N,N-dimethylethanolamine, N,N-diethylethanolamine, triethylamine, ethyldiisopriopylamine, tripropylamine, triisopropylamine and tri-n-butylamine.

The base used in step (v) is preferably an amine carrying only one amino group, more preferably, the base used in step (v) is preferably an amine carrying only one tertiary amino group.

The base reacts with at least part of the COOH groups present in the polyurethane to form salts of the COOH groups.

The base is preferably used in amounts that the ratio of mol salt groups of COOH groups/(mol COOH groups and salt groups thereof) is in the range of from 40 to 100%, more preferably in the range of from 50 to 100% all COOH groups.

The removal of at least part, preferably all, of the organic solvent of the dispersion obtained in step (vi) in step (vii) can be done by distillation.

The additive of step (vii) can be selected from the group consisting of emulsifying agents, dispersing agents, thickening agents or rheology modifying agents.

Also part of the present invention is an aqueous composition comprising a polyurethane carrying COOH groups and/or salt groups thereof, which composition is obtainable by the process of the present invention for the preparation of an aqueous composition comprising a polyurethane carrying COOH groups and/or salt groups thereof.

The aqueous composition comprising a polyurethane carrying COOH groups and/or salt groups thereof of the present invention preferably has a solid content in the range of 10 to 70% by weight based on the composition, more preferably of in the range of 20 to 60% by weight based on the composition, even more preferably of in the range of 30 to 50% by weight based on the composition and most preferably in the range of 35 to 45% by weight based on the weight of the composition.

The aqueous composition comprising a polyurethane carrying COOH groups and/or salt groups thereof of the present invention preferably comprises the polyurethane carrying COOH groups and/or salt groups thereof in the range of 10 to 70% by weight based on the weight of the composition, more preferably of in the range of 20 to 60% by weight based on the weight of the composition, even more preferably of in the range of 30 to 50% by weight based on the weight of the composition and most preferably in the range of 35 to 45% by weight based on the weight of the composition.

The aqueous composition comprising a polyurethane carrying COOH groups and/or salt groups thereof of the present invention preferably has a viscosity in the range of 1 to 500 mPas, more preferably in the range of 5 to 250 mPas, most preferably in the range of 10 to 200 mPas. The viscosity is determined using DIN ISO 2555,2018.

The aqueous composition comprising a polyurethane carrying COOH groups and/or salt groups thereof of the present invention preferably has a pH in the range of 5 to 10, more preferably in the range of 5.5 to 9.0.

The polyurethane carrying COOH groups and/or salt groups thereof present in the aqueous composition preferably has a number average molecular weight Mn in the range of 1000 g/mol to 100000 g/mol, more preferably in the range of 3500 g/mol to 50000 g/mol, most preferably in the range of 6000 g/mol to 25000 g/mol.

The polyurethane carrying COOH groups and/or salt groups thereof present in the aqueous composition preferably has a weight average molecular weight Mw in the range of 5000 g/mol to 200000 g/mol, more preferably in the range of 8000 g/mol to 100000 g/mol, most preferably in the range of 10000 g/mol to 50000 g/mol.

The number average molecular weight Mn and the weight average molecular weight Mw are determined using gel permeation chromatography calibrated to a polystyrene standard.

The polyurethane carrying COOH groups and/or salt groups thereof present in the aqueous composition preferably has a hydroxyl number in the range of 5 to 250 mg KOH/g, more preferably in the range of 10 to 200 mg KOH/g, even more preferably in the range of 20 to 150 mg KOH/g, and most preferably in the range of 30 to 100 mg KOH/g.

The hydroxyl number of the polyurethane carrying COOH groups and/or salt groups thereof present in the aqueous composition can be determined according to DIN53240, 2016.

The COOH groups and salt groups thereof density of the polyurethane carrying COOH groups and/or salt groups thereof present in the aqueous composition is preferably at least at least 0.30 mmol COOH groups and salt groups thereof/1 g of solidpolyurethane carrying COOH groups and/or salt groups thereof, and more preferably at least 0.40 mmol COOH groups and salt groups thereof/1 g of solid polyurethane carrying COOH groups and/or salt groups thereof, and most preferably at least 0.45 mmol COOH groups and salt groups thereof/1 g of solid polyurethane carrying COOH groups and/or salt groups thereof.

The maximum COOH groups and salt groups thereof density of the polyurethane carrying COOH groups and/or salt groups thereof present in the aqueous composition is preferably 0.6 mmol COOH groups and salt groups thereof/1 g of solidpolyurethane carrying COOH groups and/or salt groups thereof.

The ratio of mol salt groups of COOH groups/(mol COOH groups and salt groups thereof) of the polyurethane carrying COOH groups and/or salt groups thereof present in the aqueous composition is preferably in the range of from 40 to 100%, more preferably in the range of from 50 to 100% all COOH groups.

The particles of the aqueous composition comprising a polyurethane carrying COOH groups and/or salt groups thereof of the present invention have preferably an average particle size in the range of 1 to 200 nm, more preferably in the range of 5 to 150 nm, even more preferably in the range of 5 to 100 nm and most preferably in the range of 10 to 80 nm. The average particle size is determined using dynamic light scattering (DLS) ISO 22412, 2017.

The aqueous composition comprising a polyurethane carrying COOH groups and/or salt groups thereof of the present invention preferably does not comprise particles having a particle size of >125 μm. This is determined by filtering the aqueous composition comprising at least one polyurethane carrying COOH groups and/or salt groups thereof using a 125 μm filter.

Also part of the present invention is a process for the preparation of an aqueous composition comprising a polyurethane/poly(meth)acrylate hybrid polymer comprising the step of
(i) polymerizing at least one compound (D1) selected from the group consisting of acrylic acid ester carrying one CH₂═CH—C(═O)—O group and methacrylic acid ester carrying one CH₂=C(CH₃)—C(═O)—O group in the presence of the aqueous composition comprising a polyurethane carrying COOH groups and/or salt groups thereof of the present invention, and optionally in the presence of at least one compound different from D1 (D2) carrying at least one ethylenically unsaturated group.

The phrase “poly(meth)acrylate” encompasses polyacrylate, polymethacrylate as well as poly(acrylate/methyacrylate).

The at least one compound (D1) is preferably selected from the group consisting of acrylic acid ester carrying one CH₂═CH—C(═O)—O group and methacrylic acid ester carrying one CH₂═C(CH₃)—C(═O)—O group, wherein the acrylic acid ester is of formula CH₂═CH—C(O)—OR¹ wherein R¹ is substituted or unsubstituted C₁₋₂₀-alkyl, substituted or unsubstituted C₅₋₈-cycloalkyl or substituted or unsubstituted C₆₋₁₀-aryl, and the methacrylic acid ester is of formula CH₂═CH(CH₃)C(═O)—OR², wherein R² is substituted or unsubstituted C₁₋₂₀-alkyl, substituted or unsubstituted C₅₋₈-cycloalkyl or substituted or unsubstituted C₆₋₁₀-aryl.

The ratio of [mol acrylic acid esters carrying CH₂═CH—C(═O)—O group of formula CH₂═CH—C(O)OR¹ wherein R¹ is unsubstituted C₁₋₂₀-alkyl and methacrylic acid ester carrying one CH₂═C(CH₃)—C(═O)—O group of formula CH₂═CH(CH₃)C(═O)—OR², wherein R² is unsubstituted C₁₋₂₀-alkyl]/[mol all acrylic acid esters carrying CH₂═CH—C(═O)—O group and methacrylic acid ester carrying one CH₂═C(CH₃)—C(═O)—O group] can be in the range of 50 to 100%, more preferably is in the range of 80 to 100%, even more preferably is in the range of 90 to 100% and most preferably is in the range of 95 to 100%.

Substituted C₁₋₂₀-alkyl can be substituted with oxiranyl, O—[C₁₋₆-alkylene]₀₋₅-O—C₁₋₆-alkyl, O—C(═O)—CH₂—C(═O)—C₁₋₆-alkyl, O—(C═O)—C₁₋₆-alkyl, C₅₋₈-cycloalkyl and/or C₆₋₁₀-aryl. Substituted C₁₋₂₀-alkyl is preferably substituted with oxiranyl, O—[C₁₋₆-alkylene]₀₋₅-O—C₁₋₆-alkyl and O—C(═O)—CH₂—C(═O)—C₁₋₆-alkyl. Substituted C₁₋₂₀-alkyl is more preferably substituted with oxiranyl.

Substituted C₅₋₈-cycloalkyl can be substituted with O—(C═O)—C₁₋₆-alkyl, C₁₋₆-alkyl and/or C₆₋₁₀-aryl.

Substituted C₆-10-aryl can be substituted with O—(C═O)—C₁₋₆-alkyl, C₁₋₆-alkyl and/or C₅₋₈-cycloalkyl.

C₁₋₆-alkyl and C₁₋₂₀-alkyl can be branched or unbrached. Examples of C₁₋₆-alkyl are methyl, ethyl, propyl, isopropyl, butyl, isobutyl, sec-butyl tert-butyl, pentyl, 2-pentyl, 3-pentyl, 2-methylbutyl, 3-methylbutyl, 2,2-dimethylpropyl, hexyl, 2-hexyl and 3-hexyl. Examples of C₁₋₂₀-alkyl are methyl, ethyl, propyl, isopropyl, butyl, isobutyl, sec-butyl, tert-butyl, pentyl, 2-pentyl, 3-pentyl, 2-methylbutyl, 3-methylbutyl, 2,2-dimethylpropyl, hexyl, 2-hexyl, 3-hexyl heptyl, octyl, 2-ethylhexyl, nonyl, decyl, undecyl, dodecyl, tridecyl, tetradecyl, pentadecyl, hexadecyl, heptadecyl, octadecyl, nonadecyl and eicosyl.

Examples of C₁₋₆-alkylene are methylene, 1,2-ethylene, 1,3-propylene, 1,4-butylene, 1,5-pentylene and 1,6-hexylene. Examples of C₅₋₈-cycloalkyl are cyclopentyl, cyclohexyl, cycloheptyl and cyclooctyl. Examples of C₆₋₁₀-aryl are phenyl and 1-naphthyl and 2-naphthyl.

Examples of CH₂═CH—C(O)—OR¹, wherein R¹ is unsubstituted C₁₋₂₀-alkyl are methyl acrylate, ethyl acrylate, n-propy acrylate, buty acrylate, isobutyl acrylate, sec-butyl acrylate, tert-butyl acrylate, pentyl acrylate, isopentyl acrylate, 2-methylbutyl acrylate, amyl acrylate, hexyl acrylate, 2-ethylbutyl acrylate, heptyl acrylate, octyl acrylate, 2-ethylhexyl acrylate, 2-propylheptyl acrylate, nony acrylate, decyl acrylate, undecyl acrylate and dodecyl acrylate.

Examples of CH₂═C(CH₃)—C(O)—OR², wherein R² is unsubstituted C₁₋₂₀-alkyl are methyl methacrylate, ethyl methacrylate, n-propyl methacrylate, butyl methacrylate, isobutyl methacrylate, secbutyl methacrylate, tert-butyl methacrylate, pentyl methacrylate, isopentyl methacrylate, 2-methylbutyl methacrylate, amyl methacrylate, hexyl methacrylate, 2-ethylbutyl methacrylate, heptyl methacrylate, octyl methacrylate, 2-ethylhexyl methacrylate, 2-propylheptylmethacrylate, nony methacrylate), decyl methacrylate, undecyl methacrylate and dodecylmethacrylate.

Examples of CH₂═CH—C(O)—OR¹, wherein R¹ is substituted C₁₋₂₀-alkyl are glycidyl acrylate, [C₁₋₆-alkoxy(C₁₋₆-alkoxy)₀₋₅]C₁₋₂₀-alkyl acrylates such 2-methoxyethyl acrylate, 2-ethoxyethyl acrylate, 4-methoxybutyl acrylate and 2-(2′-methoxyethoxy)ethyl acrylate, as well as 2-(acryloyloxy)ethyl acetoacetate, 2-(acryloyloxy)propyl acetoacetate and 2-(acryloyloxy)butyl acetoacetate.

Examples of CH₂═C(CH₃)—C(O)—OR², wherein R² is substituted C₁₋₂₀-alkyl are glycidyl methacrylate, [C₁₋₆-alkoxy(C₁₋₆-alkoxy)₀₋₅]C₁₋₁₀-alkyl methacrylates such 2-methoxyethyl methacrylate, 2-ethoxyethyl methacrylate, 4-methoxybutyl methacrylate and 2-(2′-methoxyethoxy)ethyl methacrylate, as well as 2-(methacryloyloxy)ethyl acetoacetate, 2-(methacryloyloxy)propyl acetoacetate and 2-(methacryloyloxy)butyl acetoacetate.

Examples of CH₂═CH—C(O)—OR¹, wherein R¹ is unsubstituted C₅₋₈-cycloalkyl are cyclopentyl acrylate, cyclohexyl acrylate, cycloheptyl acrylate and cyclooctyl acrylate.

Examples of CH₂═C(CH₃)—C(O)—OR², wherein R² is unsubstituted C₅₋₈-cycloalkyl are cyclopentyl methacrylate, cyclohexyl methacrylate, cycloheptyl methacrylate and cyclooctyl methacrylate.

Examples of CH₂═CH—C(O)—OR¹, wherein R¹ is unsubstituted C₆₋₁₀-aryl are phenyl acrylate and 2-naphthyl acrylate.

Examples of CH₂═C(CH₃)—C(O)—OR², wherein R² is unsubstituted C₆₋₁₀-aryl are phenyl methacrylate and 2-naphthyl methacrylate.

The at least one compound (D1) is more preferably selected from the group consisting of acrylic acid ester carrying CH₂═CH—C(═O)—O group and methacrylic acid ester carrying one CH₂═C(CH₃)—C(═O)—O group, wherein the acrylic acid ester is of formula CH₂═CH—C(O)—OR¹ wherein R¹ is substituted or unsubstituted C₁₋₂₀-alkyl, substituted or unsubstituted C₅₋₈-cycloalkyl, and the methacrylic acid ester is of formula CH₂═CH(CH₃)C(═O)—OR², wherein R² is substituted or unsubstituted C₁₋₂₀-alkyl, or substituted or unsubstituted C₅₋₈-cycloalkyl.

The at least one compound (D1) is even more preferably selected from the consisting of acrylic acid ester carrying CH₂═CH—C(═O)—O group and methacrylic acid ester carrying one CH₂═C(CH₃)—C(═O)—O group, wherein the acrylic acid ester is of formula CH₂═CH—C(O)—OR¹ wherein R¹ is substituted or unsubstituted C₁₋₂₀-alkyl and the methacrylic acid ester is of formula CH₂═CH(CH₃)C(═O)—OR², wherein R² is substituted or unsubstituted C₁₋₂₀-alkyl.

The at least one compound (D1) is most preferably selected from the group consisting of methyl acrylate, ethyl acrylate, n-propy acrylate, buty acrylate, isobutyl acrylate, sec-butyl acrylate, tertbutyl acrylate, pentyl acrylate, isopentyl acrylate, 2-methylbutyl acrylate, amyl acrylate, hexyl acrylate, 2-ethylbutyl acrylate, heptyl acrylate, octyl acrylate, 2-ethylhexyl acrylate, glycidyl acrylate, methyl methacrylate, ethyl methacrylate, n-propy methacrylate, buty methacrylate, isobutyl methacrylate, sec-butyl methacrylate, tert-butyl methacrylate, pentyl methacrylate, isopentyl methacrylate, 2-methylbutyl methacrylate, amyl methacrylate, hexyl methacrylate, 2-ethylbutyl methacrylate, heptyl methacrylate, octyl methacrylate, 2-ethylhexyl mehacrylate and glycidyl methacrylate.

Compounds different from D1 (D2) carrying at least one ethylenically unsaturated group can carry one ethylenically unsaturated group or more than one ethylenically unsaturated group.

Examples of compounds different from D1 (D2) carrying one ethylenically unsaturated group are acrylic acid, methacrylic acid, acrylonitrile, methacrylonitrile, acrylamide, methacrylamide, diacetone acrylamide, diacetone methacrylamide, alpha, beta-unsaturated carboxylic acids different from methacrylic acid and acrylic acid such as crotonic acid and their C₁₋₂₀-alkyl esters, nitriles and amides, unsaturated C₂-3-aliphatic compounds such ethylenic unsaturated diacids such as fumaric acid, itaconic acid and maleic acid as well as their anhydrides such as maleic anhydride, ethylene, propylene, isobutylene, butadiene and isoprene, C₆₋₂₀-aromatic compounds carrying one vinyl group such as styrene, vinyl toluene, 2-n-butyl styrene, 4-n-butyl styrene and 4-n-decyl styrene, vinyl esters of saturated C₁₋₂₀-fatty acids such as vinyl acetate, vinyl propionate, vinyl stearate and vinyl laurate, vinyl ethers of C₁₋₁₀-alcohols such as vinyl methyl ether, vinyl isobutyl ether, vinyl hexyl ether and vinyl octyl ether, vinyl amides such as N-vinyl formamide, N-vinyl pyrrolidone and N-vinyl caprolactam, as well as heteroaromatic compounds carrying one vinyl group such as N-vinyl imidazole.

Examples of compounds different from D1 (D2) carrying more than one ethylenically unsaturated group are allyl (meth)acrylate, methallyl (meth)acrylate, 1,2-ethyleneglycol di(meth)acrylate, 1,2-propyleneglycol di(meth)acrylate, 1,3-propyleneglycol di(meth)acrylate, 1,2-butanediol di(meth)acrylate, 1,3-butanediol-di(meth)acrylate, 1,4-butanediol di(meth)acrylate, neopentylglycol di(meth)acrylate, 1,6-hexanediol di(meth)acrylate, 1,9-nonanediol di(meth)acrylate, 1,10-decanediol di (methacrylate), diethyleneglycol di(meth)acrylate, triethylene glycol di(meth)acrylate, tetraethyleneglycol di(meth)acrylate, tri(methylol)propane tri(meth)acrylate, tri(methylol)ethane tri(meth)acrylate, pentaerythritol tetra(meth)acrylate, ditrimethylolpropane tetra(meth)acrylate, dipentaerythritol hexa(meth)acrylate and divinylbenzene.

The ratio of [mol all compounds D1]/[mol all compounds D2 and all compounds D1] is preferably in the range of 50 to 100%, more preferably in the range of 80 to 100%, even more preferably in the range of 90 to 100%, most preferably in the range of 95/100. In particular, compound D2 is not present.

The at least one compound D1, and if present the at least one compound D2, are preferably polymerized in the presence of at least one suitable initiator.

The initiator can be a peroxide-type initiator, an azo-type initiator or a redox initiator system-type initiator.

Examples of peroxide-type initiators are potassium peroxodisulate, sodium peroxodiulfate, ammonium peroxodisulfate, hydrogen peroxide and tert-butyl hydroperoxide.

Examples of azo-type initiatosr are 2,2′-azobis(2-amidoisopropane) dihydrochloride, 2,2′-azobis(N,N′-dimethyleneisobutyramidine)dihydrochloride and 2,2′-azobis(4-cyanopentanoic acid).

Examples of redox initiator system-type initiator are combinations of an oxidizing compound and a reducing compound. Examples of oxidizing compounds are the peroxide-type initiators listed above. Examples of reducing compounds are reducing sulfur compounds such as alkali metal or ammonium bisulfites, sulfites, thiosulfates, dithionites or tetra-thionates, as well as alkali metal hydroxymethane sulfinate dihydrates, thiourea, and sulfinic acid derivatives.

Further examples of reducing compounds are ascorbic acid and erythorbic acid and salts thereof. Examples of a redox initiator initiator system type initiators are the combination of ammonium peroxodisulfate and ammonium disulfite as well as the combination of tert-butylhydroperoxide and sodium erythrobate. The weight ratio of oxidizing compound to the reducing compound is preferably 50:1 to 0.05:1.

The initiator is preferably a peroxide-type initiator or a redox initiator system-type initiator, more preferably a redox initiator system-type initiator.

The ratio weight initiator/[weight D1 and, if present, D2] is preferably in the range of 0.05% to 20%, more preferably in the range of 0.05% to 10%, even more preferably in the range of 0.1% to 5%, and most preferably in the range of 0.5% to 2.5%.

The at least one compound D1, and if present the at least one compound D2, are preferably polymerized in the presence of at least one suitable catalyst.

Examples of suitable catalysts are transition metal catalysts, for example iron salts or complexes, nickel salts or complexes, cobalt salts or complexes, manganese salts or complexes, copper salts or complexes, vanadium salts or complexes, chromium salts or complexes, such as iron(II) sulfate, cobalt(II) chloride, nickel(II) sulfate, copper(I) chloride, manganese(II) acetate, vanadium(II) acetate, manganese(II) chloride. Preferably, the catalyst is an iron salt or complex.

The ratio of weight catalyst/[weight D1 and D2, if present] can be in the range of 0.1 to 1000 ppm, preferably is in the range of 1 to 600 ppm, more preferably in the range of 50 to 400 ppm.

The ratio (weight D1 and, if present, D2)/(weight polyurethane present in the aqueous composition of the present invention) is preferably in the range of 30/1 to 1/30, more preferably in the range of 10/1 to 1/10 even more preferably in the range of 5/1 to 1/5, and most preferably in the range of 3/1 to 1/3.

The polymerization is usually performed in the presence of water. Minor amounts of organic solvent may also be present. The ratio weight organic solvent/[weight water and organic solvent] is preferably in the range of 0 to 35%, preferably in the range of 10 to 30% and most preferably in the range of 15 to 30%.

The polymerization is usually performed at a temperature in the range of from 15 to 160° C., preferably in the range of from 40 to 100° C.

The polymerization can be performed by feeding the at least one compound D1, and if present at least one compound D2, to a mixture comprising the aqueous composition comprising at least one polyurethane carrying COOH groups and/or salt groups thereof of the present invention, and optionally in the presence of at least one compound different from D1 (D2), at least one initiator and at least one catalyst. If more than one compound D1 is fed to the mixture, the compounds can be fed in parallel or subsequentially.

Also part of the present invention is the aqueous composition comprising a polyurethane/poly(meth)acrylate hybrid polymer obtainable by the process of the present invention for the preparation of an aqueous composition comprising a polyurethane/poly(meth)acrylate hybrid polymer.

The aqueous composition comprising a polyurethane/poly(meth)acrylate hybrid polymer of the present invention preferably has a solid content in the range of 10 to 70 weight %, more preferably in the range of 20 to 60 weight %, most preferably in the range of 30 to 50 weight %.

The aqueous composition comprising a polyurethane/poly(meth)acrylate hybrid polymer of the present invention preferably comprises the polyurethane/poly(meth)acrylate hybrid polymer of the present invention in the range of 10 to 70 weight % based on the weight of the composition, more preferably in the range of 20 to 60 weight % based on the weight of the composition, most preferably in the range of 30 to 50 weight % based on the weight of the composition.

The aqueous composition comprising a polyurethane/poly(meth)acrylate hybrid polymer of the present invention preferably has pH in the range of 5 to 10, more preferably in the range of 6 to 9, most preferably in the range of 6.5 to 7.5.

The aqueous composition comprising a polyurethane/poly(meth)acrylate hybrid polymer of the present invention preferably has an average particle size of 1 to 300 nm, more preferably in the range of 5 to 200, even more preferably in the range of 5 to 150 nm, even more preferably 5 to 100 nm and most preferably in the range of 10 to 80 nm. The average particle size is determined using dynamic light scattering (DLS) ISO 22412, 2017.

The aqueous composition comprising a polyurethane/poly(meth)acrylate hybrid polymer preferably comprises less than 20 μg, more preferably less than 10 μg, even more preferably less then 5 μg, particles having a particle size of >125 μm/1 g one polyurethane/poly(meth)acrylate hybrid polymer. This is determined by filtering the aqueous composition comprising at least one polyurethane/poly(meth)acrylate hybrid polymer using a 125 μm filter.

Also part of the present invention is a coating composition comprising
(i) the aqueous composition comprising a polyurethane carrying COOH groups and/or salt groups thereof of the present invention or the aqueous composition comprising a polyurethane/poly(meth)acrylate hybrid polymer of the present invention, and
(ii) at least one polymeric binder (E1) carrying functional groups reactive towards functional groups of the polyurethane carrying COOH groups and/or salt groups thereof present in the aqueous composition of the present invention or towards functional groups of the polyurethane/poly(meth)acrylate hybrid polymer present in the aqueous composition of the present invention, and
(iii) optionally at least one polymeric binder (E2) and different from polymeric binder E1, and also different from the polyurethane present in the aqueous composition of the present invention, different from the polyurethane/poly(meth)acrylate hybrid polymer present in the aqueous composition of the present invention.

Examples of polymeric binder E1 are polymeric binders are polyisocyanates, melamine formaldehyde resins, urea formaldehyde resins, polycarbodiimides, polyaziridines, epoxy resins. Polyisocyanates can be blocked or unblocked polyisocyanates.

Preferably, the polymeric binder E1 is a melamine formaldehyde resin or a polyisocyanate.

More preferably, the polymeric binder E1 is a melamine formaldehyde resin.

Examples of polymeric binders (E2) are poly(meth)acrylates, alkyd resins, polyesters, polycarbonates, polyethers and polythioether, and also polyurethane and polyurehane/poly(meth)acrylate hybrids, which are different from from the polyurethane carrying COOH groups and/or salt groups thereof and from the polyurethane/poly(meth)acrylate hybrid polymer present in the aqueous compositions of the present invention.

The coating compositions of the present invention can also comprise typical coating additives such as emulsifying agents, dispersing agents, thickening agents or rheology modifying agents, matting agents, wetting agents, defoaming agents and pigments. Preferably, the coating composition does not comprise pigments.

Also part of the present invention is a substrate coated with the coating composition of the present invention comprising the aqueous composition comprising a polyurethane carrying COOH groups and/or salt groups thereof of the present invention, or an aqueous composition comprising a polyurethane/poly(meth)acrylate hybrid polymer of the present invention.

The substrate can be any suitable substrates. The substrate can be wood, plastic, metal, coated metal, paper, glass, textiles, leather, fiber reinforced composites and mixtures thereof. The substrate can have the form of housings and other structural parts used to build vehicles, for example automobiles or used in all types of industrial and domestic applications. Preferred substrates are plastic, metal and coated metal.

Also part of the present invention is a process for coating a substrate, which comprises the step of applying the coating compositions comprising the aqueous composition comprising a polyurethane carrying COOH groups and/or salt groups thereof of the present invention or the aqueous composition comprising the polyurethane/poly(meth)acrylate hybrid polymer of the present invention to the substrate.

The coating compositions of the present invention can be applied to the substrate by any method known in the art such as by draw down bar, spraying, troweling, knifecoating, brushing, rolling, rollercoating, flowcoating and laminating.

Also part of the present is the use of the aqueous composition comprising a polyurethane carrying COOH groups and/or salt groups thereof, of the present invention as a binder suitable for use in coating compositions.

Also part of the present is the use of the aqueous composition comprising a polyurethane/poly(meth)acrylate hybrid polymer of the present invention as a binder suitable for use in coating compositions.

The process for the preparation of an aqueous composition comprising at least one polyurethane carrying COOH groups and/or salt groups thereof, of the present invention is advantageous in that the overall time for steps (i), (ii) and (iii) is short. The time needed for steps (i), (ii) and (iii) is preferably less than 15 hours, more preferably less than 12 hours.

In addition, the process for the preparation of an aqueous composition comprising at least one polyurethane carrying COOH groups and/or salt groups thereof, of the present invention is advantageous in that it yields aqueous composition comprising at least one polyurethane carrying COOH groups and/or salt groups thereof, wherein the at least one polyurethane carrying COOH groups and/or salt groups thereof has a small average particle size, for example in the range of 5 to 150 nm, preferably in the range of 5 to 100 nm, more preferably in the range of 10 to 80 nm, and at the same time a relative high COOH groups and salt groups thereof density, for example of at least 0.30 mmol, preferably at least 40 mmol, more preferably at least 0.45 mmol COOH groups and salt groups thereof/1 g of solid polyurethane carrying COOH groups and/or salt groups thereof. The maximum COOH groups and salt groups thereof density of the polyurethane of the aqueous composition obtained by the process of the present invention is preferably 0.6 mmol COOH groups and salt groups thereof/1 g of solid polyurethane carrying COOH groups and/or salt groups thereof. The preferred range of the COOH groups and salt groups thereof density of the polyurethane of the aqueous composition obtained by the process of the present invention is from 0.40 to 0.60, more preferably from 0.45 to 0.60, mmol COOH groups or salt groups thereof/1 g polyurethane. In addition, the process is advantageous in that it yields an aqueous composition comprising at least one polyurethane carrying COOH groups and/or salt groups thereof, that does not comprise particles having a particle size of >125 μm at all.

In addition, the process for the preparation of an aqueous composition comprising at least one polyurethane carrying COOH groups and/or salt groups thereof, of the present invention is advantageous in that in yields aqueous composition comprising at least one polyurethane carrying COOH groups and/or salt groups thereof having a high solid content, for example in the range of at least 35% by weight, more preferably at least 38% by weight, and at the same time a low viscosity, for example in the range of 10 to 200 mPas.

In addition, the process for the preparation of an aqueous composition comprising at least one polyurethane carrying COOH groups and/or salt groups thereof of the present invention is advantageous in that it yields aqueous composition comprising polyurethane carrying COOH groups and/or salt groups thereof, which composition is storage stable. In particular, the aqueous composition comprising at least one polyurethane carrying COOH groups and/or salt groups thereof does not show a significant increase in viscosity when stored in combination with melamine formaldehyde resin for 1 week at 40° C.

The aqueous composition comprising a polyurethane carrying COOH groups and/or salt groups thereof of the present invention is advantageous in that the polyurethane carrying COOH groups and/or salt groups thereof present in the composition has a small average particle size, for example in the range of 5 to 150 nm, preferably in the range of 5 to 100 nm, more preferably in the range of 10 to 80 nm, and a relative high COOH groups and salt groups thereof density, for example of at least 0.30 mmol, preferably at least 40 mmol, more preferably at least 0.45 mmol COOH groups and salt groups thereof/1 g of solid polyurethane carrying COOH groups and/or salt groups thereof. The maximum COOH groups and salt groups thereof density is preferably 0.60 mmol COOH groups and salt groups thereof/1 g of solid polyurethane carrying COOH groups and/or salt groups thereof. The preferred range of the COOH groups and salt groups thereof density of the polyurethane of the aqueous composition of the present invention is from 0.40 to 0.60, more preferably from 0.45 to 0.60, mmol COOH groups or salt groups thereof/1 g polyurethane. In addition, the aqueous composition comprising a polyurethane carrying COOH groups and/or salt groups thereof is advantageous in that it does not comprise particles having a particle size of >125 μm at all.

In addition, the aqueous composition comprising polyurethane carrying COOH groups and/or salt groups thereof, of the present invention is advantageous in that the composition has a high solid content, for example in the range of at least 35% by weight, more preferably of at least 38% by weight, and at the same time a low viscosity, for example in the range of 10 to 200 mPas.

In addition, the aqueous composition comprising a polyurethane carrying COOH groups and/or salt groups thereof of the present invention is advantageous in that it is storage stable. In particular, the aqueous composition comprising at least one polyurethane carrying COOH groups and/or salt groups thereof of the present invention does not show a significant increase in viscosity when stored in combination with melamine formaldehyde resin for 1 week at 40° C.

The process for the preparation of an aqueous composition comprising polyurethane/poly(meth)acrylate hybrid polymer of the present invention is advantageous in that it yields aqueous composition comprising polyurethane/poly(meth)acrylate hybrid having a small average particle size, for example in the range of 5 to 200 nm, preferably in the range of 5 to 150 nm, even more preferably in thereof 5 to 100 nm, and most preferably in the range of 10 to 80 nm. In addition, the aqueous composition comprising polyurethane/poly(meth)acrylate hybrid polymer obtained by the process of the present invention does only comprise a very low amount of particles having a particle size of >125 m, for example less than 20 μg, preferably less than 10 μg, and more preferably less than 5 μg particles have a particle size of >125 μm/1 g one polyurethane/poly(meth)acrylate hybrid polymer.

In addition, the process for the preparation of an aqueous composition comprising polyurethane/poly(meth)acrylate hybrid polymer of the present invention is advantageous in that it yields an aqueous composition comprising polyurethane/poly(meth)acrylate hybrid polymer that is storage stable. In particular, the aqueous composition comprising comprising polyurethane/poly(meth)acrylate hybrid polymer of the present invention does not show a significant increase in viscosity when stored in combination with melamine formaldehyde resin for 3 weeks at 40° C.

In addition, the process for the preparation of an aqueous composition comprising polyurethane/poly(meth)acrylate hybrid polymer of the present invention is advantageous in that it yields an aqueous composition comprising polyurethane/poly(meth)acrylate hybrid polymer that does not show coagulation in the presence of electrolytes, in particular it does not show coagulation in the presence of 0.1% ZnSO₄ solution, 0.2% ZnSO₄ solution and 0.1% CaCl₂ solution, respectively.

The aqueous composition comprising a polyurethane/poly(meth)acrylate hybrid polymer of the present invention is advantageous in that it has a small average particle size, for example in the range of 5 to 200 nm, preferably in the range of 5 to 150 nm, even more preferably in the range of 5 to 100 nm, and most preferably in the range of 10 to 80 nm. In addition, the aqueous composition comprising polyurethane/poly(meth)acrylate hybrid polymer of the present invention comprise a very low number of particles having a particle size of >125 m, for example less than 20 μg, preferably less than 10 μg, and more preferably less than 5 μg particles have a particle size of >125 μm/1 g one polyurethane/poly(meth)acrylate hybrid polymer.

In addition, the aqueous composition comprising a polyurethane/poly(meth)acrylate hybrid polymer of the present invention is advantageous in that it is storage stable. In particular, the aqueous composition comprising comprising polyurethane/poly(meth)acrylate hybrid polymer of the present invention does not show a significant increase in viscosity when stored in combination with melamine formaldehyde resin for 3 weeks at 40° C.

In addition, the aqueous composition comprising polyurethane/poly(meth)acrylate hybrid polymer of the present invention is advantageous in that it does not show coagulation in the presence of electrolytes, in particular it does not show coagulation in the presence of 0.1% ZnSO₄ solution, 0.2% ZnSO₄ solution and 0.1% CaCl₂ solution, respectively.

### EXAMPLES

The average particle size is the average particle size determined using dynamic light scattering (DLS) ISO 22412, 2017.

The hydroxyl number is determined using DIN53240, 2016.

The viscosity is determined using DIN ISO 2555,2018.

The number average molecular weight Mn and the weight average molecular weight Mw are determined using gel permeation chromatography calibrated to a polystyrene standard.

The electrolyte stability of an aqueous polymer dispersion in 0.1% ZnSO₄ solution, 0.2% ZnSO₄ solution and 0.1% CaCl₂ solution, respectively, is determined as follows: A test tube is filled with 0.1% by weight aqueous solution of ZnSO4, with 0.2% by weight aqueous ZnSO₄ solution or with 0.1% by weight aqueous CaCl₂ solution to a height of approximately 2 cm. Then, one drop of the aqueous dispersion of the polymer to be tested is dropped into the solution in the test tube, and the mixture is lightly shaken before evaluation. The test mixture is then evaluated by visually inspection. If coagulation is present in the mixture, the aqueous polymer dispersion fails the test, if no coagulation is present in the mixture, the aqueous polymer dispersion passes the test.

### Example 1

Preparation of an Aqueous Dispersion Comprising Polyurethane PU1 Having a Degree of Neutralization of the COOH Groups of 95% and a COOH Groups and Salt Groups Thereof Density of 0.50 Mmol COOH Groups and Salt Groups Thereof/1 g Sold Polyurethane Using a Sequential Process

Dimethylolpropionic acid (69.8 g, 0.52 mol) and water-free acetone (300 g) was added to a reactor and heated to 55° C. (inside temperature) under stirring. After 30 minutes, hexamethylene diisoocyanate (101 g, 0.6 mol) was added, followed by addition of water-free acetone (10 g).

The reaction mixture was allowed to react at 55° C. until the NCO value (weight NCO groups/weight reaction mixture) reached 7% (which took around 3 to 4 hours). The reaction index of this step according to formula 1 is 0.38.

The reaction index is calculated as follows:
reaction rate=1 minus (mol NCO groups of C1/mol initial NCO groups of all A1), wherein mol NCO groups of C1 is (NCO content of C1×weight C1)/molecular weight NCO
thus reaction rate=1 minus [(NCO content of C1×weight C1)/(mol initial NCO groups of all A1×molecular weight NCO)]
NCO content of C1=7%=0.07
Weight C1=480.8
Mol initial NCO groups of all A1=1.2 mol
Molecular weight NCO=42 g/mol
reaction rate=1 minus (0.07×480.8 g)/(1.2 mol×42 g/mol)=1 minus (33.6 g/50.4 g)=1 minus 0.67=0.33

reaction index=reaction rate×[mol initial NCO groups of all A1/(mol initial OH groups of all BX and, if present, mol initial OH groups of all B1)] (formula 1)
mol initial NCO groups of all A1=1.20 mol
mol initial OH groups of all BX=1.04 mol
reaction index=0.33×(1.20 mol/1.04 mol)=0.38

Then, Lupraphen 7600/1 (a polyester diol, OH number: 56 mg KOH/g) (800 g) was added to the reaction mixture within 15 minutes, followed by addition of acetone (80 g). The reaction mixture was allowed to react at 60° C. (inside temperature) until the NCO value reached below 0.05% (which took around 4 hours). Basonat H1100 NG (hexamethylene diisocyanate trimer, 23% NCO content) (10.8 g, 0.056 mol NCO) was added to the reaction mixture, and the reaction mixture was allowed to react until the NCO value reached again below 0.05% (which took around 1 hour). The reaction mixture was cooled to room temperature and diluted with acetone (800 g). N,N-Diethylethanolamine (57.8 g, 0.49 mol) was added to the reaction mixture, followed by addition of water (1450 g). After acetone was removed by distillation, Disponil FES 77 (27.2 g) was added to obtain aqueous dispersion comprising polyurethane PU1 and having a solid content of 42.1%, a pH of 7.7, an average particle size of 41 nm and a viscosity of 120 mPas. When filtering the aqueous dispersion comprising polyurethane PU1 via a filter with a filter size of 125 m, no particles remained in the filter, showing that the aqueous dispersion comprising polyurethane PU1 does not contain particles with a particle size >125 μm. The polyurethane PU1 has a number average molecular weight Mn of 12000 g/mol, a weight average molecular weight Mw of 26000 g/mol and a hydroxyl number of 57 mg KOH/g.

### Example 2

Preparation of an Aqueous Dispersion Comprising Polyurethane PU2 Having a Degree of Neutralization of the COOH Groups of 75% and a COOH Groups and Salt Groups Thereof Density of 0.51 Mmol COOH Groups and Salt Groups Thereof/1 g Sold Polyurethane Using a Sequential Process

The aqueous dispersion comprising polyurethane PU2 was prepared in analogy to the aqueous dispersion comprising polyurethane PU1 in example 1, except that N,N-diethylethanolamine (45.68 g, 0.39 mol) was added to the reaction mixture instead of N,N-diethylethanolamine (57.8 g, 0.49 mol) to yield an aqueous dispersion comprising polyurethane PU2 having a solid content of 42.0%, a pH of 6.3, an average particle size of 57 nm and a viscosity of 33 mPas. When filtering the aqueous dispersion via a filter with a filter size of 125 μm, no particles remained in the filter, showing that the aqueous dispersion comprising polyurethane PU2 does not contain particles with a particle size >125 μm. The polyurethane PU2 has a number average molecular weight Mn of 11000 g/mol, a weight average molecular weight Mw of 23000 g/mol and a hydroxyl number of 57 mg KOH/g.

### Example 3

Preparation of an aqueous dispersion comprising polyurethane PU3 having a degree of neutralization of the COOH groups of 60% and a COOH groups and salt groups thereof density of 0.51 mmol COOH groups and salt groups thereof/1 g sold polyurethane using a sequential process

The aqueous dispersion comprising polyurethane PU3 was prepared in analogy to the aqueous dispersion comprising polyurethane PU1 in example 1, except that N,N-diethylethanolamine (36.55 g, 0.31 mol) was added to the reaction mixture instead of N,N-diethylethanolamine (57.8 g, 0.49 mol) to yield an aqueous dispersion comprising polyurethane PU3 having a solid content of 41.5%, a pH of 6.0, an average particle size of 53 nm and a viscosity of 14 mPas. When filtering the aqueous dispersion via a filter with a filter size of 125 m, no particles remained in the filter, showing that the aqueous dispersion comprising polyurethane PU3 does not contain particles with a particle size >125 μm. The polyurethane PU3 has a number average molecular weight Mn of 11000 g/mol, a weight average molecular weight Mw of 23000 g/mol and a hydroxyl number of 57 mg KOH/g.

### Comparative Example 1

Preparation of a Comparative Aqueous Dispersion Comprising Polyurethane compPU1 Having a Degree of Neutralization of the COOH Groups of 95% and a COOH Groups and Salt Groups Thereof Density of 0.50 Mmol COOH Groups and Salt Groups Thereof/1 g Sold Polyurethane Using a Batch Process

Dimethylolpropionic acid (69.8 g, 0.52 mol), water-free acetone (300 g) and Lupraphen 7600/1 (a polyester diol, OH number: 56 mg KOH/g) (800 g, 0.4 mol) were added to a reactor and heated to 55° C. (inside temperature) under stirring. After 30 minutes, hexamethylene diisoocyanate (Basonat H, 101 g, 0.6 mol) was added, followed by addition of water-free acetone (10 g). The reaction mixture was allowed to react at 60-65° C. until the NCO value (weight NCO groups/weight reaction mixture) reached below 0.05% (which took around 18 to 19 hours). After that, Basonat H1100 NG (hexamethylene diisocyanate trimer, 23% NCO content) (10.8 g, 0.056 mol NCO) was added to the reaction mixture, and the reaction mixture was allowed to react until the NCO value reached again below 0.05% (which took around 3 hour). The reaction mixture was cooled to room temperature and diluted with acetone (800 g). N,N-Diethylethanolamine (57.8 g, 0.49 mol) was added to the reaction mixture, followed by addition of water (1450 g). After acetone was removed by distillation, Disponil FES 77 (27.2 g) was added to yield an aqueous dispersion comprising polyurethane compPU1 having a solid content of 42.7%, a pH of 7.5, an average particle size of 116 nm and a viscosity of 53 mPas. When filtering the aqueous dispersion comprising polyurethane compPU1 via a filter with a filter size of 125 m, 130 μg polymer particles/g polyurethane compPU1 remained in the filter, showing that the aqueous dispersion comprising polyurethane compPUD1 contains particles with a particle size >125 μm.

The polyurethane compPU1 has a number average molecular weight Mn of 19000 g/mol, a weight average molecular weight Mw of 45000 g/mol and a hydroxyl number of 57 mg KOH/g.

### Comparative Example 2

Preparation of a Comparative Aqueous Dispersion Comprising Polyurethane compPU2 Having a Degree of Neutralization of the COOH Groups of 75% and a COOH Groups and Salt Groups Thereof Density of 0.51 Mmol COOH Groups and Salt Groups Thereof/1 g Sold Polyurethane Using a Batch Process

The aqueous dispersion comprising polyurethane compPU2 was prepared in analogy to the aqueous dispersion comprising polyurethane compPUD1 in comparative example 1, except that N,N-diethylethanolamine (45.68 g, 0.39 mol) was added to the reaction mixture instead of N,N-diethylethanolamine (57.8 g, 0.49 mol) to yield an aqueous dispersion comprising polyurethane compPU2 having a solid content of 42.8%, a pH of 6.3, an average particle size of 334 nm, and a viscosity of 66 mPas. When filtering the aqueous dispersion comprising compPUD2 via a filter with a filter size of 125 m, 155 μg polymer particles/g polyurethane compPU2 remained in the filter, showing that the aqueous dispersion comprising polyurethane compPUD2 contains particles with a particle size >125 μm. The polyurethane compPU2 has a number average molecular weight Mn of 15000 g/mol, a weight average molecular weight Mw of 33000 g/mol and a hydroxyl number of 57 mg KOH/g.

### Comparative Example 3

Preparation of a Comparative Aqueous Dispersion Comprising Polyurethane compPU3 Having a Degree of Neutralization of the COOH Groups of 60% and a COOH Groups and Salt Groups Thereof Density of 0.51 Mmol COOH Groups and Salt Groups Thereof/1 g Sold Polyurethane Using a Batch Process

The aqueous dispersion comprising polyurethane compPU3 was prepared in analogy to the aqueous dispersion comprising polyurethane compPU1 in comparative example 1, except that N,N-diethylethanolamine (36.55 g, 0.31 mol) was added to the reaction mixture instead of N,N-diethylethanolamine (57.8 g, 0.49 mol) to yield an aqueous dispersion comprising polyurethane compPU3 having a solid content of 42.5% and a pH of 6.1. The average particle size, the viscosity, the number average mocular weight as well as the weight average molecular weight could not be determined. When filtering the aqueous dispersion comprising compPU3 via a filter with a filter size of 125 m, 41 μg polymer particles/g polyurethane compPU3 remained in the filter, showing that the aqueous dispersion comprising compPUD3 contains particles with a particle size >125 μm. The polyurethane compPU3 has a hydroxyl number of 57 mg KOH/g. The average particle size, the viscosity and the number average molecular weight as well as the weight average molecular weight could not be determined.

### Example 4

### Preparation of an Aqueous Dispersion Comprising Polyurethane/Poly(Meth)Acrylate Hybrid PUPA-1, Wherein the Polyurethane PU1 of Example 1 is Used as Starting Material

In a polymerization vessel equipped with metering devices and temperature control, 143.5 g of deionized water, 475.1 g of the aqueous dispersion comprising polyurethane PU1 of example 1, and 8.0 g of Dissolvine E-Fe-6 (containing 0.5 weight % of an iron-based catalyst) was added. The mixture was heated to 60° C., and then 14.0 g of 10 weight % solution of tert-butyl hydroperoxide in water was charged, followed by addition of 8.5 g deionized water (rinsing water). After 5 min, 67.37 g of solution of 1.9 weight % solution of sodium erythorbate in water was fed over 175 min. 5 min after start of sodium erythorbate feed, 100 g methyl methacrylate was fed to the reactor over 75 min. After the methyl methacrylate feed, a feed consisting of 92 g n-butyl acrylate and 8 g glycidyl methacrylate was fed over 40 min. The reaction temperature is kept at 60° C. After the sodium erythorbate feed, the reaction mixture was kept for another 30 min at 60° C. and then cooled to room temperature to obtain an aqueous dispersion comprising polyurethane/poly(meth)acrylate hybrid PUPA1 having a solid content of 40%, a pH of 7, and an average particle size of 46 nm. When filtering the aqueous dispersion comprising polyurethane/poly(meth)acrylate hybrid PUPA1 via a filter with a filter size of 125 m, only 4 μg polymer particles/g polyurethane/poly(meth)acrylate hybrid PUPA1 remained in the filter, showing that the aqueous dispersion comprising polyurethane/poly(meth)acrylate hybrid PUPA1 only contains a very low number of particles with a particle size >125 μm. The aqueous dispersion comprising polyurethane/poly(meth)acrylate hybrid PUPA1 passed the electrolyte stability test in 0.1% ZnSO₄ solution, 0.2% ZnSO₄ solution and 0.1% CaCl₂ solution, respectively.

### Comparative Example 4

Preparation of a Comparative Aqueous Dispersion Comprising the Polyurethane/Poly(Meth)Acrylate Hybrid compPUPA1, Wherein the Polyurethane compPU1 of Comparative Example 1 is Used as Starting Material

The aqueous dispersion comprising polyurethane/poly(meth)acrylate hybrid compPUPA1 was prepared in analogy to the aqueous dispersion comprising PUPA1 of example 4, except that the aqueous dispersion comprising polyurethane compPU1 of comparative example 1 was used instead of the aqueous dispersion comprising polyurethane PU1 of example 1. The obtained aqueous dispersion comprising the polyurethane/poly(meth)acrylate hybrid compPUPA1 has a solid content of 40%, a pH of 7, and an average particle size of 140 nm. When filtering the aqueous dispersion comprising compPUPA1 via a filter with a filter size of 125 m, 52 μg polymer particles/g polyurethane/poly(meth)acrylate hybrid compPUPA1 remained in the filter, showing that the aqueous dispersion comprising polyurethane/poly(meth)acrylate hybrid compPUPA1 contains particles with a particle size >125 μm. The aqueous dispersion comprising polyurethane/poly(meth)acrylate hybrid compPUPA1 passed the electrolyte stability test in 0.1% ZnSO₄ solution but failed the test in 0.2% ZnSO₄ solution and 0.1% CaCl₂ solution, respectively.

### Example 5

Storage stability of a formulation comprising the aqueous dispersion comprising polyurethane PU2 of example 2 and Luwipal® 073 LF in comparison to the storage stability of a formulation comprising the aqueous dispersion comprising polyurethane compPU2 of comparative example 2 and Luwipal® 073 LF

21.3 g of the aqueous dispersion comprising polyurethane PU2 of example 2 and 78.7 g Luwipal® 073F (melamine formaldehyde resin) were mixed, and the pH was adjusted to a pH of in the range of 7.5 to 8.0. The viscosity of the formulation obtained was determined directly after pH adjustment and after storage at 40° C. for 1 week. The viscosity directly after pH adjustment was 18.0 mPas, the viscosity after 1-week storage at 40° C. was 24.0 mPas.

21.3 g of the comparative aqueous dispersion comprising polyurethane compPU2 of comparative example 2 and 78.7 g Luwipal® 073F (melamine formaldehyde resin) were mixed, and the pH was adjusted to pH in the range of 7.5 to 8.0. The viscosity of formulation obtained was determined directly after pH adjustment and after storage at 40° C. for 1 week. The viscosity directly after pH adjustment was 34.0 mPas, the viscosity after 1-week storage at 40° C. was >80.0 mPas.

Thus, the viscosity of the formulation comprising the aqueous dispersion comprising polyurethane PU2 of example 2 having a degree of neutralization of the COOH groups of 75% and being prepared using a sequential process and 78.7 g Luwipal® 073F (melamine formaldehyde resin) does only increase slightly from 18.0 to 24.0 mPas upon storage for 1 week at 40° C., whereas the viscosity of the comparative formulation comprising the comparative aqueous dispersion comprising polyurethane compPU2 of comparative example 2 having a degree of neutralization of the COOH groups of 75% and being prepared using a batch process and 78.7 g Luwipal® 073F (melamine formaldehyde resin) increases significantly from 34.0 mPas to >80.0 mPas upon storage for 1 week at 40° C.

### Example 6

Storage stability of a formulation comprising the aqueous dispersion comprising the polyurethane/poly(meth)acrylate hybrid PUPA1 of example 4 and Luwipal® 073 LF in comparison to the storage stability of a formulation comprising the aqueous dispersion comprising the polyurethane/poly(meth)acrylate hybrid compPUPA1 of comparative example 4 and Luwipal® 073 LF

30.0 g of the aqueous dispersion comprising the polyurethane/poly(meth)acrylate hybrid PUPA1 of example 4 and 70.0 g Luwipal® 073F (melamine formaldehyde resin) was mixed, and the pH was adjusted to a pH in the range of 7.5 to 8.0. The viscosity of the formulation obtained was determined directly after pH adjustment and after storage at 40° C. for 1 week, and 3 weeks. The viscosity directly after pH adjustment was 13.0 mPas, the viscosity after 1-week storage at 40° C. was 13.0 mPas, the viscosity after 3-weeks storage at 40° C. was 13.0 mPas.

30.0 g of the comparative aqueous dispersion comprising a polyurethane/poly(meth)acrylate hybrid (compPUPA1) of comparative example 4 and 70.0 g Luwipal® 073F (melamine formaldehyde resin) was mixed, and the pH was adjusted to a pH in the range of 7.5 to 8.0. The viscosity of the formulation obtained was determined directly after pH adjustment and after storage at 40° C. for 1 week, and 3 weeks. The viscosity directly after pH adjustment was 13.0 mPas, the viscosity after 1-week storage at 40° C. was 14.0 mPas, the viscosity after 3-weeks storage at 40° C. was >80.0 mPas.

Thus, the viscosity of a formulation comprising the aqueous dispersion comprising a polyurethane/poly(meth)acrylate hybrid PUPA1 of example 4, wherein the polyurethane PU1 of example 1 having a degree of neutralization of the COOH groups of 95% and being prepared by a sequential process is used as starting material, and 78.7 g Luwipal® 073F (melamine formaldehyde resin) does not increase when stored for 3 weeks at 40° C., whereas the viscosity of the comparative formulation comprising the aqueous dispersion comprising a polyurethane/poly(meth)acrylate hybrid compPUPA1 of comparative example 4, wherein the polyurethane compPU1 of comparative example 1 having a degree of neutralization of the COOH groups of 95%, and being prepared by a batch process is used as starting material, and 78.7 g Luwipal® 073F (melamine formaldehyde resin) does not significantly increase when stored for 1 week at 40° C., but significantly increases from 14.0 mPas to >80.0 mPas when stored for 3 weeks at 40° C.

### Example 7

Preparation of an Aqueous Dispersion Comprising Polyurethane PU4 Having a Degree of Neutralization of the COOH Groups of 95% and a COOH Groups and Salt Groups Thereof Density of 0.325 Mmol COOH Groups and Salt Groups Thereof/1 g Sold Polyurethane Using a Sequential Process

Dimethylolpropionic acid (48.29 g, 0.36 mol), Lupraphen 7600/1 (a polyester diol, hydroxyl number: 56 mg KOH/g) (280 g), water-free acetone (300 g) and Borchi Kat 315 (0.2 g) were added to a reactor and heated to 55° C. (inside temperature) under stirring. After 30 minutes, hexamethylene diisoocyanate (90.83 g, 0.54 mol) and 4,4′-diisocyanato-dicyclohexylmethane (14.96 g, 0.057 mol) were added, followed by addition of water-free acetone (10 g). The reaction mixture was allowed to react at 55° C. until the NCO value (weight NCO groups/weight reaction mixture) reached 3.06% (which took around 2 hours). The reaction index of this step as calculated according to formula 1 is 0.65.

The reaction index is calculated as follows:
reaction rate=1 minus (mol NCO groups of C1/mol initial NCO groups of all A1), wherein mol NCO groups of C1 is (NCO content of C1×weight C1)/molecular weight NCO
thus
reaction rate=1 minus [(NCO content of C1×weight C1)/(mol initial NCO groups of all A1×molecular weight NCO)]
NCO content of C1=3.06%=0.0306
Weight C1=745 g
Mol initial NCO groups of all A1=1.2 mol
Molecular weight NCO=42 g/mol
reaction rate=1 minus (0.0306×745 g)/(1.2 mol×42 g/mol)=1 minus (22.8 g/50.4 g)=1 minus 0.45=0.55

reaction index=reaction rate×[mol initial NCO groups of all A1/(mol initial OH groups of all BX and, if present, mol initial OH groups of all B1)] (formula 1)
mol initial NCO groups of all A1=1.2 mol
mol initial OH groups of all BX=1.0 mol
reaction index=0.55×(1.2 mol/1.0 mol)=0.66

Then, Lupraphen 7800/1 (a polyester diol, OH number: 112 mg KOH/g) (630 g) was added to the reaction mixture within 20 minutes, followed by addition of acetone (80 g) and Borch Kat 315 (0.3 g). The reaction mixture was allowed to react at 70° C. (inside temperature) until the NCO value reached below 0.05% (which took around 4 hours). Basonat H1100 NG (hexamethylene diisocyanate trimer, 23% NCO content) (11.2 g) were added to the reaction mixture, and the reaction mixture was allowed to react at 70° C. (inside temperature) until the NCO value reached again below 0.05% (which took around 1 hour). The reaction mixture was diluted with acetone (790 g) and cooled to 35° C. N,N-Dimethylethanolamine (30.5 g, 0.342 mol) was added to the reaction mixture, followed by addition of water (1600 g). Acetone was removed by distillation and the pH was adjusted with N,N-dimethylethanolamine to 8.5 to obtain an aqueous dispersion comprising polyurethane PU4 and having a solid content of 41%, a pH of 8.5, an average particle size of 38 nm, a viscosity of 169 mPas. When filtering the aqueous dispersion comprising polyurethane PU4 via a filter with a filter size of 125 m, no particles remained in the filter, showing that the aqueous dispersion comprising polyurethane PU4 does not contain particles with a particle size >125 μm. The polyurethane PU4 has a number average molecular weight Mn of 3300 g/mol, a weight average molecular weight Mw of 12000 g/mol and a hydroxyl number of 67 mg KOH/g.

### Example 8

### Preparation of an Aqueous Dispersion Comprising Polyurethane/Poly(Meth)Acrylate Hybrid PUPA2, Wherein the Polyurethane PU2 of Example 2 is Used as Starting Material

In a polymerization vessel equipped with metering devices and temperature control, 669.60 g of deionized water, 2403.11 g of the aqueous dispersion comprising polyurethane PU2 of example 2 and 40.18 g Dissolvine E-Fe-6 (containing 0.50 weight % of an iron-based catalyst) was added. The mixture was heated to 60° C., and then 70.32 g methyl methacrylate was charged, followed by 70.32 g of a 10 weight % solution of tert-butyl hydroperoxide in water. The vessel, which contained tert-butyl hydroperoxide, was rinsed with 42.99 g deionized water, and this water is also charged. After 5 min, 158.61 g of a 1.9 weight % solution of sodium erythorbate in water was fed over 80 min. 5 min after start of the sodium erythorbate feed, 572.57 g methyl methacrylate, 10.05 g allyl methacrylate and 41.00 g 2-hydroxyethyl methacrylate were fed to the reactor over 75 min. After the feed of the monomers and sodium erythrobate, the vessel, which contained sodium erythrobate solution, as well as the vessel, which contained the mixture of methyl methacrylate, allyl methacrylate and 2-hydroxyethyl acrylate, were rinsed with 52.23 g and 214.56 g deionized water, respectively, and this water is also charged. The reaction mixture is stirred at 60° C. for 30 minutes. Then, 179.75 g of a solution of 1.9% sodium erythorbate is fed over 95 min, and simultaneously 261.17 g n-butyl acrylate, 40.18 g glycidyl methacrylate and 10.05 g allyl methacrylate were fed to the reactor over 40 min. After the feed of the monomers, the vessels, which contained n-butyl acrylate, glycidyl methacrylate and allyl methacrylate, were rinsed with 52.23 g deionized water, and this water was also charged. After the sodium erythorbate feed, the reaction mixture is kept for another 30 min at 60° C., and the cooled to room temperature. A solution of 11.85 g N,N-dimethylethanolamine in 15.67 g water was added, and the vessel, which contained N,N-dimethylethanolamine and water, was rinsed with 84.18 g water to obtain an aqueous dispersion comprising polyurethane/poly(meth)acrylate hybrid PUPA2 having a solid content of 40%, a pH of 7.4, and an average particle size of 93 nm. When filtering the aqueous dispersion comprising polyurethane/poly(meth)acrylate hybrid PUPA2 via a filter with a filter size of 125 m, only 40 μg polymer particles/g polyurethane/poly(meth)acrylate hybrid PUPA2 remained in the filter, showing that the aqueous dispersion comprising polyurethane/poly(meth)acrylate hybrid PUPA1 only contains a very low amount of particles with a particle size >125 μm.

1.-22. (canceled)

23. A process for the preparation of an aqueous composition comprising a polyurethane carrying COOH groups and/or salt groups thereof, comprising the steps of
(i) reacting at least one first polyisocyanate (A1) with at least one polyol carrying at least one COOH group (BX) and optionally a first polyol carrying no COOH group (B1) to form a first composition (C1),
(ii) treating the first composition (C1) obtained in step (i) with at least one second polyol carrying no COOH groups (B2), and optionally with at least one second polyisocyanate (A2), to form a second composition (C2), and
(iii) optionally treating the second composition (C2) obtained in step (ii) with at least one third polyisocyanate (A3), to form a third composition (C3),
wherein step (i) is stopped at a reaction index in the range of 0.05 to 0.94,
wherein
reaction index=reaction rate×[mol initial NCO groups of all A1/(mol initial OH groups of all BX and, if present, mol initial OH groups of all B1)] (formula 1)
wherein
reaction rate=1 minus (mol NCO groups of C1/mol initial NCO groups of all A1).

24. The process of claim 23, wherein step (i) is stopped at a reaction index in the range of 0.10 to 0.80.

25. The process of claim 23, wherein the first polyisocyanate (A1) is an aliphatic or alicyclic polyisocyanate having an NCO functionality in the range of 1.8 to 2.5.

26. The process of claim 23, wherein the polyol carrying at least one COOH group (BX) is an aliphatic or alicyclic polyol having an OH functionality in the range of 1.8 to 2.4, a number average molecular weight of below 500 g/mol, and carrying one COOH group.

27. The process of claim 23, wherein the first polyol carrying no COOH group (B1), if present, and the second polyol carrying no COOH group (B2) independently from each other have an OH functionality in the range of 1.8 to 2.4 and a number average molecular weight of at least 750 g/mol.

28. The process of claim 23, wherein the first polyol carrying no COOH group (B1), if present, and the second polyol carrying no COOH group (B2) independently from each other are selected from the group consisting of polyester polyol carrying no COOH groups, polycarbonate polyol carrying no COOH groups and polyether polyol carrying no COOH groups.

29. The process of claim 23, wherein in step (iii) the second composition (C2) obtained in step (ii) is treated with at least one third polyisocyanate (A3), to form a third composition (C3), and the third polyisocyanate (A3) is an aliphatic or alicyclic polyisocyanate having an NCO functionality in the range of 1.8 to 4.0.

30. The process of claim 23, wherein the ratio (initial mol NCO groups of all A1)/(initial mol OH groups of all BX and, if present, initial OH group of all B1) in step (i) is in the range of 1.5/1 to 0.9/1.

31. The process of claim 23, wherein the ratio of (mol initial OH groups of all BX and, if present, of all B1)/(mol OH groups of all B2) is in the range of 2/1 to 1/2.

32. The process of claim 29, wherein the ratio of (mol initial NCO groups of all A1)/(mol NCO groups of all A3) is in the range of 40/1 to 5/1.

33. The process of claim 29, wherein the ratio (mol NCO groups of all A1, if present, of all A2, and of all A3)/(mol OH groups of all BX, if present of all B1, and of all B2) is in the range of 1/1 to 1/5.

34. An aqueous composition comprising a polyurethane carrying COOH groups and/or salt groups thereof obtained by the process of claim 23.

35. The aqueous composition comprising a polyurethane carrying COOH groups and/or salt groups thereof of claim 34, wherein the COOH groups and salt groups thereof density of the polyurethane carrying COOH groups and/or salt groups thereof present in the aqueous composition is at least at least 0.30 mmol COOH groups and salt groups thereof/1 g of solid polyurethane carrying COOH groups and/or salt groups thereof.

36. The aqueous composition comprising a polyurethane carrying COOH groups and/or salt groups thereof of claim 34, wherein the average particle size of the polyurethane carrying COOH groups and/or salt groups thereof is in the range of 5 to 150 nm.

37. The aqueous composition comprising a polyurethane carrying COOH groups and/or salt groups thereof of claim 34, wherein the polyurethane has a hydroxyl number in the range of 5 to 250 mg KOH/g.

38. A process for the preparation an aqueous composition comprising a polyurethane/poly(meth)acrylate hybrid polymer comprising the step of
(i) polymerizing at least one compound (D1) selected from the group consisting of acrylic acid ester carrying one CH2=CH—C(═O)—O group and methacrylic acid ester carrying one CH2=C(CH3)-C(═O)—O group in the presence of the aqueous composition comprising a polyurethane carrying COOH groups and/or salt groups thereof of claim 34, and optionally in the presence of at least one compound different from D1 (D2) carrying at least one ethylenically unsaturated group.

39. The process for the preparation an aqueous composition comprising a polyurethane/poly(meth)acrylate hybrid polymer of claim 38, wherein a ratio of weight D1 and, if present, D2 to weight polyurethane present in the aqueous composition is in the range of 30/1 to 1/30.

40. An aqueous composition comprising a polyurethane/poly(meth)acrylate hybrid polymer obtainable by the process of claim 38.

41. The aqueous composition comprising a polyurethane/poly(meth)acrylate hybrid polymer of claim 40, wherein the average particle size of the polyurethane/poly(meth)acrylate hybrid polymer is in the range of 5 to 200 nm.

42. A coating composition comprising
(i) the aqueous composition comprising a polyurethane carrying COOH groups and/or salt groups thereof claim 34, and
(ii) at least one polymeric binder (E1) carrying functional groups reactive towards functional groups of the polyurethane carrying COOH groups and/or salt groups thereof present in the aqueous composition of claim 34, and
(iii) optionally at least one polymeric binder (E2) different from binder E1, and also different from the polyurethane present in the aqueous composition of claim 34.

43. The coating composition of claim 42, wherein the polymeric binder E1 is present and is a melamine formaldehyde resin or a polyisocyanate.

44. A substrate coated with the coating composition of claim 42.
